(19) United States
(12) Patent Application Publication
(10) Pub. No.: US 2025/0151079 A1
(43) Pub. Date: May 8, 2025

(54) METHOD AND APPARATUS FOR TRANSMITTING AND RECEIVING UPLINK SIGNALS FOR COVERAGE ENHANCEMENT IN WIRELESS COMMUNICATION SYSTEM

(71) Applicant: SAMSUNG ELECTRONICS CO., LTD., Suwon-si (KR)

(72) Inventor: Youngbum KIM, Suwon-si (KR)

(21) Appl. No.: 18/934,033

(22) Filed: Oct. 31, 2024

(30) Foreign Application Priority Data
Nov. 3, 2023 (KR) 10-2023-0150938

(51) Int. Cl. H04W 72/231; H04L 27/26; H04W 72/1268; H04W 72/51

(52) U.S. Cl. CPC H04W 72/231; H04L 27/2636; H04W 72/1268; H04W 72/51

(57) ABSTRACT

The disclosure relates to a 5G or 6G communication system for supporting higher data rates. The disclosure relates to a method and apparatus capable of transmitting and receiving uplink signals for coverage enhancement in a wireless communication system. The method comprises: receiving, via a PDCCH, DCI scheduling a PUSCH transmission, wherein the DCI includes first information associated with a PUSCH transmission waveform; determining, based on the first information, whether the PUSCH transmission waveform is a DFT-s-OFDM or the PUSCH transmission waveform is changed from a recent PUSCH transmission waveform; identifying, based on a processing time parameter; determining whether to transmit the PUSCH transmission based on the PUSCH preparation time; and transmitting the PUSCH transmission in response to determining to transmit the PUSCH transmission.

### CROSS-REFERENCE TO RELATED APPLICATION

This application is based on and claims priority under 35 U.S.C. § 119 to Korean Patent Application No. 10-2023-0150938 filed on Nov. 3, 2023, in the Korean Intellectual Property Office, the disclosure of which is incorporated by reference herein in its entirety.

### BACKGROUND

### 1. Field

The disclosure relates to a communication method in a wireless communication system and, more particularly, to a method and apparatus for transmitting and receiving uplink signals for coverage enhancement in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

An object of the disclosed embodiments is to provide an apparatus and method capable of effectively providing services in a mobile communication system.

The technical objectives to be achieved in the disclosed embodiments are not limited to those mentioned above, and other technical objectives not mentioned may be identified by a person having ordinary skill in the art from the various embodiments of the disclosure described below.

According to an embodiment, a method performed by a user equipment (UE) in a communication system includes receiving, via physical downlink control channel (PDCCH), downlink control information (DCI) scheduling physical uplink shared channel (PUSCH) transmission, wherein the DCI includes information associated with a PUSCH transmission waveform; identifying, based on the information, that the PUSCH transmission waveform is a discrete Fourier transform spread orthogonal frequency division multiplexing (DFT-s-OFDM) or the PUSCH transmission waveform is changed from a recent PUSCH transmission waveform; identifying a PUSCH preparation time based on a processing time parameter for the PUSCH transmission waveform being the DFT-s-OFDM or the PUSCH transmission waveform being changed from the recent PUSCH transmission waveform; identifying whether to transmit the PUSCH transmission based on the PUSCH preparation time; and transmitting the PUSCH transmission in case of identifying to transmit the PUSCH transmission.

According to an embodiment, wherein the DCI includes information on the processing time parameter.

According to an embodiment, wherein a UE capability of the processing time parameter is transmitted and the PUSCH transmission is scheduled based on the UE capability of the processing time parameter.

According to an embodiment, wherein the method further includes in case that the PUSCH transmission waveform is changed from the recent PUSCH transmission waveform: identifying whether a PUSCH gap between the PUSCH transmission and a recent PUSCH transmission corresponding to the recent PUSCH transmission waveform is equal to higher than a first threshold; identifying whether a PDCCH gap between the PDCCH and a recent PDCCH scheduling the PUSCH transmission is equal to higher than a second threshold; wherein identifying whether to transmit the PUSCH transmission is further based on whether the PUSCH gap is equal to higher than the first threshold and whether the PDCCH gap is equal to higher than the second threshold, and wherein the PUSCH transmission is transmitted in case that the PUSCH gap is equal to higher than the first threshold and the PDCCH gap is equal to higher than the second threshold.

According to an embodiment, wherein the method further includes transmitting a UE capability associated with whether the UE is available to process the information, wherein the DCI includes the information in case that the UE is available to process the information.

According to an embodiment, a user equipment (UE) in a communication system includes a transceiver and a processor coupled with the transceiver and configured to receive, via physical downlink control channel (PDCCH), downlink control information (DCI) scheduling physical uplink shared channel (PUSCH) transmission, wherein the DCI includes information associated with a PUSCH transmission waveform; identify, based on the information, that the PUSCH transmission waveform is a discrete Fourier transform spread orthogonal frequency division multiplexing (DFT-s-OFDM) or the PUSCH transmission waveform is changed from a recent PUSCH transmission waveform; identify a PUSCH preparation time based on a processing time parameter for the PUSCH transmission waveform being the DFT-s-OFDM or the PUSCH transmission waveform being changed from the recent PUSCH transmission waveform; identify whether to transmit the PUSCH transmission based on the PUSCH preparation time; and transmit the PUSCH transmission in case of identifying to transmit the PUSCH transmission.

According to an embodiment, wherein the DCI includes information on the processing time parameter.

According to an embodiment, wherein a UE capability of the processing time parameter is transmitted and the PUSCH transmission is scheduled based on the UE capability of the processing time parameter.

According to an embodiment, wherein the processor is further configured to in case that the PUSCH transmission waveform is changed from the recent PUSCH transmission waveform: identify whether a PUSCH gap between the PUSCH transmission and a recent PUSCH transmission corresponding to the recent PUSCH transmission waveform is equal to higher than a first threshold; identify whether a PDCCH gap between the PDCCH and a recent PDCCH scheduling the PUSCH transmission is equal to higher than a second threshold; wherein identifying whether to transmit the PUSCH transmission is further based on whether the PUSCH gap is equal to higher than the first threshold and whether the PDCCH gap is equal to higher than the second threshold, and wherein the PUSCH transmission is transmitted in case that the PUSCH gap is equal to higher than the first threshold and the PDCCH gap is equal to higher than the second threshold.

According to an embodiment, wherein the processor is further configured to transmit a UE capability associated with whether the UE is available to process the information, and wherein the DCI includes the information in case that the UE is available to process the information.

According to an embodiment, a method performed by a base station in a communication system includes identifying that a physical uplink shared channel (PUSCH) transmission waveform is a discrete Fourier transform spread orthogonal frequency division multiplexing (DFT-s-OFDM) or the PUSCH transmission waveform is changed from a recent PUSCH transmission waveform; identifying a processing time parameter for the PUSCH transmission waveform being the DFT-s-OFDM or the PUSCH transmission waveform being changed from the recent PUSCH transmission waveform, wherein the processing time parameter is for a PUSCH preparation time; transmitting, via physical downlink control channel (PDCCH), downlink control information (DCI) scheduling the PUSCH transmission, wherein the DCI includes information associated with the PUSCH transmission waveform; and receiving the PUSCH transmission associated with the PUSCH preparation time.

According to an embodiment, wherein the DCI includes information on the processing time parameter.

According to an embodiment, wherein a user equipment (UE) capability of the processing time parameter is received and the PUSCH transmission is scheduled based on the UE capability of the processing time parameter.

According to an embodiment, wherein in case that the PUSCH transmission waveform is changed from the recent PUSCH transmission waveform: the PUSCH transmission is received in case that a PUSCH gap is equal to higher than a first threshold and a PDCCH gap is equal to higher than a second threshold, wherein the PUSCH gap is a gap between the PUSCH transmission and a recent PUSCH transmission corresponding to the recent PUSCH transmission waveform, and wherein the PDCCH gap is a gap between the PDCCH and a recent PDCCH scheduling the PUSCH transmission.

According to an embodiment, wherein the method further includes receiving a UE capability associated with whether a UE is available to process the information, wherein the DCI includes the information in case that the UE is available to process the information.

According to an embodiment, a base station in a communication system includes a transceiver; and a processor coupled with the transceiver and configured to identify that a physical uplink shared channel (PUSCH) transmission waveform is a discrete Fourier transform spread orthogonal frequency division multiplexing (DFT-s-OFDM) or the PUSCH transmission waveform is changed from a recent PUSCH transmission waveform; identify a processing time parameter for the PUSCH transmission waveform being the DFT-s-OFDM or the PUSCH transmission waveform being changed from the recent PUSCH transmission waveform, wherein the processing time parameter is for a PUSCH preparation time; transmit, via physical downlink control channel (PDCCH), downlink control information (DCI) scheduling the PUSCH transmission, wherein the DCI includes information associated with the PUSCH transmission waveform; and receive the PUSCH transmission associated with the PUSCH preparation time.

According to an embodiment, wherein the DCI includes information on the processing time parameter.

According to an embodiment, wherein a user equipment (UE) capability of the processing time parameter is received and the PUSCH transmission is scheduled based on the UE capability of the processing time parameter.

According to an embodiment, wherein in case that the PUSCH transmission waveform is changed from the recent PUSCH transmission waveform: the PUSCH transmission is received in case that a PUSCH gap is equal to higher than a first threshold and a PDCCH gap is equal to higher than a second threshold, wherein the PUSCH gap is a gap between the PUSCH transmission and a recent PUSCH transmission corresponding to the recent PUSCH transmission waveform, and wherein the PDCCH gap is a gap between the PDCCH and a recent PDCCH scheduling the PUSCH transmission.

According to an embodiment, wherein the processor is further configured to receive a UE capability associated with whether a UE is available to process the information, and wherein the DCI includes the information in case that the UE is available to process the information.

The above-described embodiments are only some of the preferred embodiments of the disclosure, and various other embodiments reflecting the technical features of various embodiments of the disclosure can be derived and understood by those skilled in the art based on the detailed description set forth below.

The disclosed embodiments provide an apparatus and method for achieving coverage improvement in a mobile communication system.

The effects obtainable from the disclosed embodiments are not limited to those effects mentioned above, and other effects not mentioned may be clearly derived and understood by a person having ordinary skill in the art based on the detailed description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a basic structure of the time-frequency resource domain of a 5G system according to an embodiment of the present disclosure;

FIG. 2 illustrate a time domain mapping structure of synchronization signals and beam sweeping operation according to an embodiment of the present disclosure;

FIG. 3 illustrate a random access procedure according to an embodiment of the present disclosure;

FIG. 4 illustrate a procedure in which the UE reports UE capability information to the base station according to an embodiment of the disclosure;

FIG. 5 illustrate a transmission signal generation according to an embodiment of the present disclosure;

FIG. 6 illustrate an operation of controlling the transmission waveform of a UE according to an embodiment of the present disclosure;

FIG. 7 illustrate a time relationship for the UE to control the transmission waveform according to an embodiment of the present disclosure;

FIG. 8 illustrate another time relationship for the UE to control the transmission waveform according to an embodiment of the present disclosure;

FIG. 9 illustrate flowchart for describing a UE procedure according to an embodiment of the present disclosure;

FIG. 10 illustrate a flowchart for describing a base station procedure according to an embodiment of the present disclosure;

FIG. 11 illustrate a UE transceiver according to an embodiment of the present disclosure;

FIG. 12 illustrate a structure of a UE according to an embodiment of the present disclosure; and

FIG. 13 illustrate a structure of a base station according to an embodiment of the present disclosure.

### DETAILED DESCRIPTION

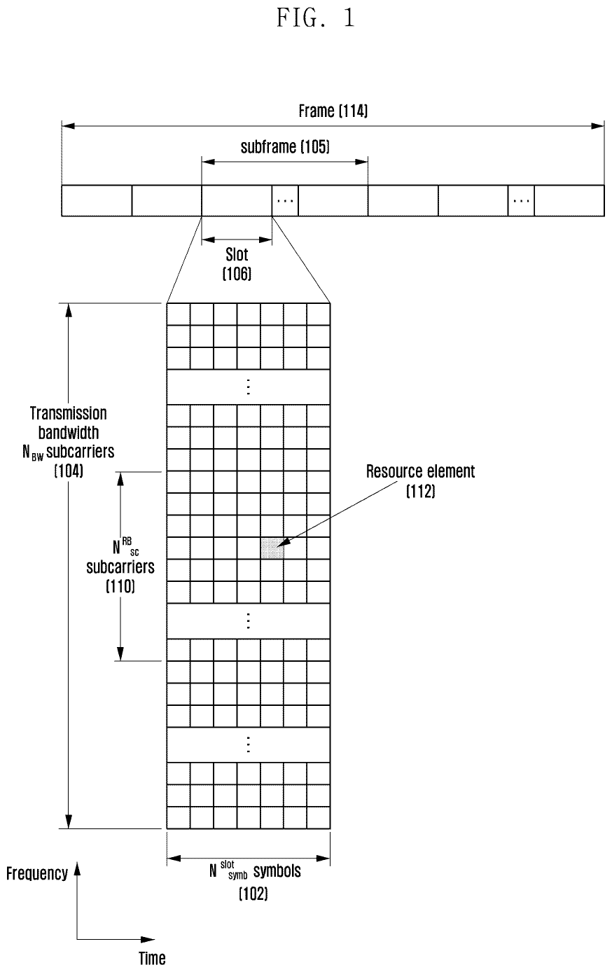

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings. In the description of the disclosure, descriptions of well-known functions and structures incorporated herein may be omitted to avoid obscuring the subject matter of the disclosure. Also, the terms described below are defined in consideration of their functions in the disclosure, and these may vary depending on the intention of the user, the operator, or the custom. Hence, their meanings should be determined based on the overall contents of this specification.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the description to refer to the same parts.

Meanwhile, it will be appreciated that blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a certain way, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for carrying out functions described in blocks of the flowchart. As the computer program instructions may be loaded on a computer or a programmable data processing equipment, when the computer program instructions are executed as processes having a series of operations on a computer or a programmable data processing equipment, they may provide steps for executing functions described in blocks of the flowchart.

Each block of a flowchart may correspond to a module, a segment or a code containing one or more executable instructions for executing one or more logical functions, or to a part thereof. It should also be noted that functions described by blocks may be executed in an order different from the listed order in some alternative cases. For example, two blocks listed in sequence may be executed substantially at the same time or executed in reverse order according to the corresponding functionality.

Here, the word “unit,” “module,” or the like used in embodiments of the disclosure may refer to a software component or a hardware component such as an FPGA (field programmable gate array) or ASIC (application specific integrated circuit) capable of carrying out a function or an operation. However, a “unit” or the like is not limited to hardware or software. A unit or the like may be configured so as to reside in an addressable storage medium or to drive one or more processors. For example, units or the like may refer to components such as a software component, object-oriented software component, class component or task component, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose larger components and units. In addition, components and units may be implemented to drive one or more processors in a device or a secure multimedia card. Further, in an embodiment, a “unit” or the like may include one or more processors.

In the following description of the disclosure, if it is determined that a detailed description of a related known function or configuration may unnecessarily obscure the gist of the disclosure, the detailed description will be omitted. Hereinafter, embodiments of the disclosure will be described with reference to the attached drawings.

Those terms used in the following description for identifying an access node, indicating a network entity, indicating a message, indicating an interface between network entities, and indicating various identification information are taken as illustration for ease of description. Accordingly, the disclosure is not limited by the terms to be described later, and other terms referring to objects having an equivalent technical meaning may be used.

In the following description, a physical channel or a signal may be used interchangeably with data or a control signal. For example, a physical downlink shared channel (PDSCH) is a term referring to a physical channel through which data is transmitted, but the PDSCH may also be used to refer to data. That is, in the disclosure, an expression “transmitting a physical channel” may be interpreted as being equivalent to an expression “transmitting data or a signal through a physical channel.”

In the disclosure, higher layer signaling (or higher signaling) indicates a method of transmitting a signal from the base station to the UE by using a downlink data channel of the physical layer, or from the UE to the base station by using an uplink data channel of the physical layer. Higher signaling may be understood as radio resource control (RRC) signaling or medium access control (MAC) control element (CE). Higher layer signaling may be referred to as radio resource control (RRC) signaling, packet data convergence protocol (PDCP) signaling, or media access control (MAC) control element (CE).

For the convenience of description, the disclosure uses terms and names defined in the 3GPP new radio (NR, 5th generation mobile communication) standard. However, the disclosure is not limited by those terms and names, and the embodiments of the disclosure may be applied to other communication systems having similar technical backgrounds or channel configurations. For example, this may include LTE or LTE-A mobile communication and mobile communication technologies developed after 5G. Therefore, it is to be understood by those skilled in the art that the embodiments of the disclosure may be applied to other communication systems without significant modifications departing from the scope of the disclosure.

In the following description, the term “base station” refers to a main agent allocating resources to terminals and may be at least one of gNode B, gNB, eNode B, eNB, Node B, BS, radio access unit, base station controller, or network node. The term “terminal” may include, but not limited to, user equipment (UE), mobile station (MS), cellular phone, smartphone, computer, IoT device, sensor, or multimedia system with a communication function.

In describing the disclosure below, higher layer signaling may be signaling corresponding to at least one of the following signalings or a combination thereof:
MIB (master information block);
SIB (system information block) or SIB X (X=1, 2, . . . );
RRC (radio resource control); and/or
MAC (medium access control) CE (control element).

Additionally, L1 (layer 1) signaling may be signaling corresponding to at least one of the following physical layer channels or signaling methods or a combination thereof:
PDCCH (physical downlink control channel);
DCI (downlink control information);
UE-specific DCI;
Group common DCI;
Common DCI;
Scheduling DCI (e.g., DCI used for scheduling downlink or uplink data);
Non-scheduling DCI (e.g., DCI not intended for scheduling downlink or uplink data);
PUCCH (physical uplink control channel); and/or
UCI (uplink control information).

The term “slot” used in the disclosure below is a general term that may refer to a specific time unit corresponding to the transmit time interval (TTI). Specifically, it may indicate a slot used in a 5G NR system and may also indicate a slot or subframe used in a 4G LTE system.

To handle the recent explosive increase in mobile data traffic, the initial standard for the 5^{th} generation (5G) system or new radio (NR) access technology, as the next-generation communication system after LTE (long term evolution or E-UTRA (evolved universal terrestrial radio access)) and LTE-A (LTE-advanced or E-UTRA evolution), has been completed. While existing mobile communication systems have focused on regular voice/data communication, the 5G systems aim to satisfy a variety of services and requirements such as high-speed broadband communication (enhanced mobile broadband, eMBB) services for improving existing voice/data communication, ultra-reliable and low latency communication (URLLC) services, and massive machine type communication (mMTC) services.

While the system transmission bandwidth per single carrier of existing LTE and LTE-A is limited to a maximum of 20 MHz, the 5G system mainly aims to provide ultra-high-speed data services reaching several Gbps by utilizing a much wider ultra-wide bandwidth. Hence, the 5G system is considering ultra-high frequency bands ranging from several GHz to up to 100 GHz, where it is relatively easy to secure ultra-wide bandwidth frequencies, as candidate frequencies. Additionally, through frequency reassignment or allocation, it is possible to secure wide bandwidth frequencies for the 5G system among the frequency bands belonging to a range from hundreds of MHz to several GHz used in existing mobile communication systems.

A radio wave of the ultra-high frequency band may be called a millimeter wave (mmWave) having a wavelength at the level of several millimeters. However, in the ultra-high frequency band, pathloss of the radio wave is increased in proportion to the frequency band, and thus the coverage of the mobile communication system is decreased.

To overcome the drawback of the coverage decrease in the ultra-high frequency band described above, beamforming technology is applied to increase the arrival distance of the radio wave by using multiple antennas to focus the radiant energy of radio waves to a specific destination point. That is, the beam width of the signal to which the beamforming technology is applied becomes relatively narrow, and radiant energy is concentrated within the narrowed beam width, thereby increasing the arrival distance of the radio wave. The beamforming technology may be applied respectively to the transmitting end and the receiving end. In addition to increasing the coverage, the beamforming technology has an effect of reducing interference in a region other than the beamforming direction. In order for the beamforming technology to operate properly, accurate transmit/receive beam measurement and feedback methods are required. The beamforming technology may be applied to control or data channels that correspond one-to-one between a given UE and base station. In addition, to increase the coverage, the beamforming technology may also be applied to control channels and data channels for transmitting common signals, such as a synchronization signal, broadcast channel (physical broadcast channel, PBCH) or system information, from the base station to multiple UEs in the system. In the case of applying beamforming technology to a common signal, a beam sweeping technology, which transmits a signal by changing the beam direction, may be additionally applied to ensure that the common signal can reach UEs located at arbitrary positions within the cell.

As another requirement for the 5G system, an ultra-low latency service with a transmission delay of approximately 1 ms between the transmitting and receiving ends is required. As a way to reduce transmission delay, it is necessary to design a frame structure based on a shorter transmission time interval (TTI) compared to LTE and LTE-A. The TTI is a basic time unit for performing scheduling, and the TTI of the existing LTE and LTE-A system is 1 ms corresponding to the length of one subframe. For example, in the 5G system, a short TTI to satisfy the requirements for ultra-low delay services may be set to 0.5 ms, 0.25 ms, or 0.125 ms, which is shorter than that of existing LTE and LTE-A systems.

FIG. 1 illustrates a basic structure of a time-frequency resource domain of a 5G system according to an embodiment of the present disclosure. That is, FIG. 1 is a diagram showing the basic structure of a time-frequency resource domain, which is a radio resource region where data or control channels of the 5G system are transmitted.

With reference to FIG. 1, in FIG. 1, the horizontal axis represents the time domain, and the vertical axis represents the frequency domain. The minimum transmission unit in the time domain of the 5G system is orthogonal frequency division multiplexing (OFDM) symbols, N_{symb}^{slot} symbols 102 may collectively constitute one slot 106, and Nₛₗₒₜ^{subframe} slot slots may collectively constitute one subframe 105. The length of the subframe 105 is 1.0 ms, and 10 subframes may collectively constitute one frame 114 of 10 ms. The minimum transmission unit in the frequency domain is a subcarrier, and the bandwidth of the entire system transmission band may be composed of a total of N_{BW} subcarriers 104.

In the time-frequency domain, the basic unit of a resource is a resource element (RE) 112, and it may be indicated by an OFDM symbol index and a subcarrier index. A resource block (RB or physical resource block (PRB)) may be defined as N_{sc}^{RB} consecutive subcarriers 110 in the frequency domain. In the 5G system, N_{sc}^{RB}=12, and the data rate may increase in proportion to the number of RBs scheduled for the UE.

In the 5G system, the base station may map data on an RB basis and may generally perform scheduling on the RBs constituting one slot for a given UE. That is, the basic time unit for scheduling in the 5G system may be a slot, and the basic frequency unit for scheduling may be an RB.

The number of OFDM symbols N_{symb}^{slot} may be determined according to the length of a cyclic prefix (CP) that is added for each symbol to prevent inter-symbol interference; for example, if a normal CP is applied, N_{symb}^{slot}=14, whereas if an extended CP is applied, N_{symb}^{slot}=12. Compared to the normal CP, the extended CP is applied to a system where the radio wave transmission distance is relatively long, so that orthogonality between symbols is maintained. In the case of a normal CP, the ratio between the CP length and the symbol length is maintained at a constant value, so that the overhead due to the CP can be maintained constant regardless of the subcarrier spacing. That is, if the subcarrier spacing is small, the symbol length becomes longer, and the CP length may also become longer accordingly. Conversely, if the subcarrier spacing is large, the symbol length becomes short, and the CP length may be reduced accordingly. The symbol length and CP length may be inversely proportional to the subcarrier spacing.

In the 5G system, various frame structures may be supported by adjusting the subcarrier spacing to satisfy various services and requirements. For example, following examples may be provided.

From a perspective of the operating frequency band, if the subcarrier spacing is larger, the more advantageous is provided for phase noise recovery in the high frequency band.

From a perspective of the transmission time, if the subcarrier spacing is larger, the symbol length in the time domain is shortened, and as a result, the slot length is shortened, which is advantageous for supporting ultra-low latency services such as URLLC.

From a perspective of the cell size, if the CP length is longer, the larger cell can be supported, so the smaller the subcarrier spacing, the more relatively large cell can be supported. In mobile communication, the cell is a concept that refers to an area covered by one base station.

The subcarrier spacing and CP length are essential information for OFDM transmission and reception, and smooth transmission and reception is possible only when the base station and the UE recognize the subcarrier spacing and CP length as common values. Table 1 shows the relationship between subcarrier spacing configuration (μ), subcarrier spacing (Δf), and CP length supported by the 5G system.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 shows, in the case of normal CP, the number of symbols per slot (N_{symb}^{slot}), the number of slots per frame (Nₛₗₒₜ^{frame,μ}), and the number of slots per subframe (Nₛₗₒₜ^{subframe,μ}) for each subcarrier spacing configuration (μ).

TABLE 2

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 shows, in the case of extended CP, the number of symbols per slot (N_{symb}^{slot}), the number of slots per frame (Nₛₗₒₜ^{frame,μ}), and the number of slots per subframe (Nₛₗₒₜ^{subframe,μ}) for each subcarrier spacing configuration (μ).

TABLE 3

| μ | N_{symb}^{slot} | Nₛₗₒₜ^{frame,μ} | Nₛₗₒₜ^{subframe,μ} |
|---|---|---|---|
| 2 | 12 | 40 | 4 |

It is expected that the 5G system may coexist with the existing LTE or/and LTE-A (LTE/LTE-A) system or may be operated in dual mode therewith at least at the beginning of introduction of the 5G system. Thereby, the existing LTE/LTE-A system may provide stable system operation to the UE, and the 5G system may provide improved services to the UE. Hence, the frame structure of the 5G system needs to include at least the frame structure or essential parameter set (subcarrier spacing=15 kHz) of LTE/LTE-A.

For example, when comparing a frame structure with subcarrier spacing configuration μ=0 (hereinafter referred to as frame structure A) and a frame structure with subcarrier spacing configuration μ=1 (hereinafter referred to as frame structure B), frame structure B corresponds to a case where the subcarrier spacing and RB size are doubled, and the slot length and symbol length are reduced by half in comparison to frame structure A. In the case of frame structure B, two slots may constitute one subframe, and 20 subframes may constitute one frame.

If the frame structure of the 5G system is generalized, where the subcarrier spacing, CP length, and slot length belong to the essential parameter set, an integer multiple relationship may be established between the subcarrier spacing, CP length, and slot length of one frame structure and those of another frame structure, so that high scalability can be provided. Further, to represent a reference time unit independent of the frame structure, a subframe with a fixed length of 1 ms may be defined.

The frame structure of the 5G system may be applied in correspondence to various scenarios. From a perspective of the cell size, the longer the CP length, the larger cell can be supported, so frame structure A can support relatively larger cells compared to frame structure B. From a perspective of the operating frequency band, the larger the subcarrier spacing, the more advantageous it is to recover phase noise in the high frequency band, so frame structure B can support a relatively higher operating frequency compared to frame structure A. From a service perspective, it is advantageous to have a shorter slot length, which is the basic time unit for scheduling, to support ultra-low-latency services such as URLLC, so frame structure B may be relatively more suitable for URLLC services compared to frame structure A.

In the following description of the disclosure, uplink (UL) may refer to a radio link through which a UE transmits data or control signals to a base station, and downlink (DL) may refer to a radio link through which a base station transmits data or control signals to a UE.

In an initial access stage in which a UE initially accesses the system, the UE may first set downlink time and frequency synchronization from a synchronization signal transmitted by the base station through cell search, and obtain a cell identity (cell ID). Then, the UE may receive a physical broadcast channel (PBCH) by using the obtained cell ID and obtain a master information block (MIB) being essential system information from the PBCH. Additionally, the UE may receive system information (system information block, SIB) transmitted by the base station to obtain cell-common control information related to transmission and reception. The cell-common control information related to transmission and reception may include random access-related control information, paging-related control information, and common control information about various physical channels.

The synchronization signal may be a reference signal for cell search, and the subcarrier spacing may be applied for each frequency band in a manner suitable to the channel environment such as phase noise. In the case of a data channel or control channel, the subcarrier spacing may be applied differently according to the service type so as to support various services as described above.

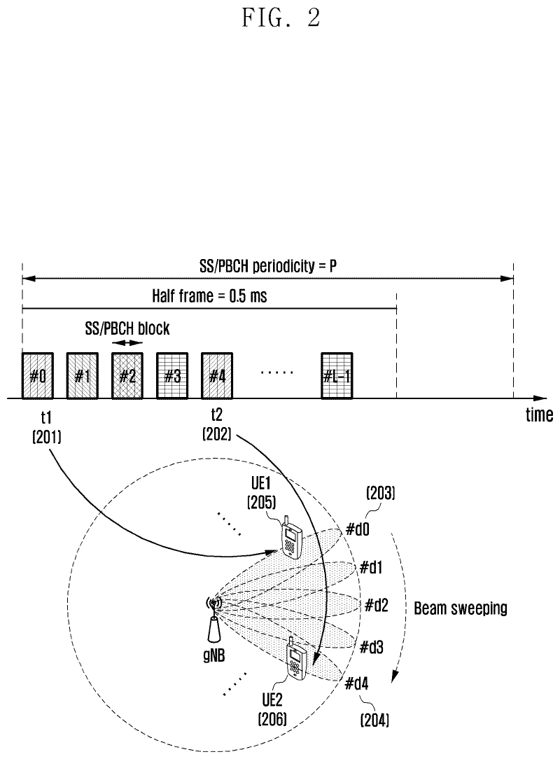

FIG. 2 illustrates a structure of mapping synchronization signals to the time domain and beam sweeping operation according to an embodiment of the present disclosure.

For description, the following constituents may be defined.

PSS (primary synchronization signal): a signal that serves as a reference for DL time/frequency synchronization and provides some information about the cell ID.

SSS (secondary synchronization signal): it serves as a reference for DL time/frequency synchronization and provides the remaining information about the cell ID. Additionally, it may serve as a reference signal for PBCH demodulation.

PBCH (physical broadcast channel): it provides MIB (master information block), which is essential system information required for transmission and reception of data channels and control channels of the UE. The MIB may include control information about a search space indicating radio resource mapping information of a control channel, scheduling control information for a separate data channel transmitting system information, and information about the system frame number (SFN) being a frame-based index serving as a timing reference.

SS/PBCH block (synchronization signal/PBCH block or SSB): an SS/PBCH block is composed of N OFDM symbols and is made up of a combination of PSS, SSS, PBCH, or the like. In the case of a system where beam sweeping technology is applied, the SS/PBCH block is the minimum unit to which beam sweeping is applied. In a 5G system, the value of N may be 4. The base station may transmit up to L SS/PBCH blocks, and the L SS/PBCH blocks are mapped within a half frame (0.5 ms). Additionally, the L SS/PBCH blocks are periodically repeated with a specific periodicity P. The periodicity P may be notified to the UE by the base station through signaling. If there is no separate signaling for the periodicity P, the UE applies a pre-agreed default value. Each SS/PBCH block may have an SS/PBCH block index ranging from 0 to L−1, and the UE may identify the SS/PBCH block index through SS/PBCH detection.

With reference to FIG. 2, in FIG. 2, beam sweeping is applied over time on a SS/PBCH block basis. In the example of FIG. 2, a UE 1 (205) uses a beam radiated in direction #d0 (203) by beamforming applied to SS/PBCH block #0 (211) at time t1 (201) to receive a SS/PBCH block. And a UE 2 (206) uses a beam radiated in direction #d4 (204) by beamforming applied to SS/PBCH block #4 at time t2 (202) to receive a SS/PBCH block. A UE may obtain an optimal synchronization signal through a beam radiated by the base station in a direction where the UE is located. For example, it may be difficult for the UE 1 (205) to obtain time/frequency synchronization and essential system information from a SS/PBCH block delivered through a beam radiated in direction #d4, which is far from the position of the UE 1.

In addition to the initial access procedure, the UE may also receive an SS/PBCH block to determine whether the radio link quality of the current cell is maintained on or above a specific level. Additionally, in a handover procedure in which the UE moves from the current cell to a neighbor cell, the UE may receive an SS/PBCH block of the neighbor cell to determine the radio link quality of the neighbor cell and obtain time/frequency synchronization of the neighbor cell.

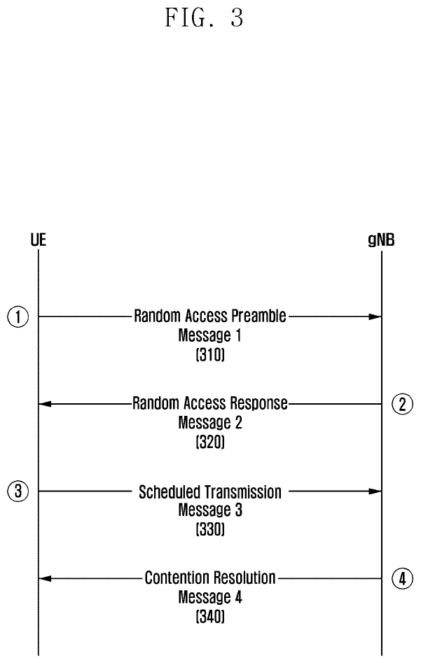

After the UE obtains the MIB and system information from the base station through the initial access procedure, the UE may perform a random access procedure to switch the link with the base station to the connected state (or an RRC_CONNECTED state). When the random access procedure is completed, the UE switches to the connected state, and one-to-one communication is possible between the base station and the UE. Next, the random access procedure will be described in detail with reference to FIG. 3.

FIG. 3 illustrates a random access procedure according to an embodiment of the present disclosure. FIG. 3 illustrates an example of a random access procedure, and the disclosure is not limited thereto. Additionally, the disclosure is not limited to the 4-step random access procedure illustrated in FIG. 3, and may also be applied to a 2-step random access procedure (transmitting and receiving message A (message including information corresponding to message 1 and message 3) and transmitting and receiving message B (message including information corresponding to message 2 and message 4)).

With reference to FIG. 3, at first step 310 of the random access procedure, the UE transmits a random access preamble to the base station. The random access preamble, which is the first message transmitted by the UE in the random access procedure, may be referred to as message 1. Based on the random access preamble, the base station may measure a transmission delay value between the UE and the base station and achieve uplink synchronization. At this time, the UE may randomly select a random access preamble to be used from a random access preamble set given in advance by system information. Additionally, the initial transmission power for the random access preamble may be determined according to the pathloss between the base station and the UE measured by the UE. Further, the UE may determine the transmit beam direction for the random access preamble based on the synchronization signal received from the base station and transmit the random access preamble.

At second step 320, the base station transmits an uplink transmission timing control command to the UE based on a transmission delay value measured from the random access preamble received at first step 310. Additionally, the base station may transmit an uplink resource and power control command to be used by the UE as scheduling information. The scheduling information may include control information about the uplink transmit beam of the UE.

If the UE fails to receive a random access response (RAR, or message 2) being scheduling information for message 3 from the base station within a specified time at second step 320, it may perform the first step 310 again. If the first step 310 is performed again, the UE may transmit the random access preamble with a transmission power increased by a specific step (power ramping) to thereby increase the probability for the base station to receive the random access preamble.

At third step 330, the UE transmits uplink data (message 3) including its UE ID to the base station by using the uplink resource allocated at second step 320 over an uplink data channel (physical uplink shared channel, PUSCH). The transmission timing of the uplink data channel for transmitting message 3 may follow the transmission timing control command received from the base station at second step 320. Additionally, the transmission power of the uplink data channel for transmitting message 3 may be determined in consideration of the power control command received from the base station at second step 320 and the power ramping value of the random access preamble. The uplink data channel for transmitting message 3 may refer to the first uplink data signal transmitted by the UE to the base station after UE's transmission of the random access preamble.

At fourth step 340, upon determining that the UE has performed random access without collision with other UEs, the base station transmits data (message 4) including the ID of the UE having transmitted the uplink data at third step 330 to the corresponding UE. If the UE receives the signal transmitted by the base station at fourth step 340, it may determine that the random access is successful. Then, the UE may transmit HARQ-ACK information indicating successful or unsuccessful reception of message 4 to the base station over an uplink control channel (physical uplink control channel, PUCCH).

If the data transmitted by the UE at third step 330 collides with data of another UE and the base station fails to receive the data signal from the UE, the base station may no longer transmit data to the UE. As a result, if the UE fails to receive data transmitted from the base station at fourth step 340 within a given time, the UE may determine that the random access procedure has failed and may start the procedure again from the first step 310.

If the random access procedure is successfully completed, the UE switches to the connected state, and one-to-one communication becomes possible between the base station and the UE. The base station may receive UE capability information from the UE in connected state and adjust scheduling in consideration of the UE capability information of the corresponding UE. Through the UE capability information, the UE may notify the base station of whether the UE itself supports a specific function, the maximum allowable value for the function supported by the UE, and the like. Hence, the UE capability information reported by each UE to the base station may have different values for individual UEs.

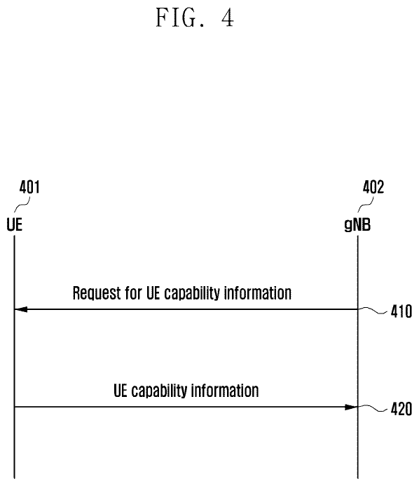

FIG. 4 illustrates a procedure in which the UE reports UE capability information to the base station according to an embodiment of the present disclosure.

With reference to FIG. 4, at step 410, the base station 402 may transmit a request message for UE capability information to the UE 401. In response to the request for UE capability information from the base station, at step 420, the UE may transmit UE capability information to the base station.

For example, the UE may report UE capability information including at least a portion of the following control information to the base station as the above UE capability information:
Control information about the frequency bands supported by the UE;
Control information about the channel bandwidth supported by the UE;
Control information about the maximum modulation scheme supported by the UE;
Control information about the maximum number of beams supported by the UE;
Control information about the maximum number of layers supported by the UE;
Control information about CSI reporting supported by the UE;
Control information about whether frequency hopping is supported by the UE;
Control information about bandwidths in the case of supporting carrier aggregation (CA); and/or
Control information about whether cross carrier scheduling is supported in the case of supporting carrier aggregation.

With reference to FIG. 4, at step 410, the base station 402 may transmit a request message for UE capability information to the UE 401. In response to the request for UE capability information from the base station, at step 420, the UE may transmit UE capability information to the base station.

Next, a detailed description will be given of downlink control information (DCI) in the 5G system.

In the 5G system, scheduling information for uplink data (or physical uplink shared channel (PUSCH)) or downlink data (or physical downlink shared channel (PDSCH)) may be delivered from the base station to the UE via DCI. The UE may monitor a fallback DCI format and a non-fallback DCI format for the PUSCH or PDSCH. A fallback DCI format may include fixed fields predefined between the base station and the UE, and a non-fallback DCI format may include fields that may be configurable.

DCI may be transmitted over a physical downlink control channel (PDCCH), which is a physical downlink control channel, through a channel coding and modulation process. A cyclic redundancy check (CRC) may be attached to the payload of a DCI message, and the CRC may be scrambled with a radio network temporary identifier (RNTI) corresponding to the identity of the UE. Different RNTIs may be used according to the purpose of the DCI message, for example, UE-specific data transmission, power control command, or random access response. That is, the RNTI is not explicitly transmitted, but is transmitted by being included in the CRC calculation process. Upon receiving a DCI message transmitted over the PDCCH, the UE may perform a CRC check by using the assigned RNTI, and if the CRC check result is correct, the UE may be aware that the corresponding message has been transmitted to it.

For example, DCI for scheduling a PDSCH for system information (SI) may be scrambled with an SI-RNTI. DCI for scheduling a PDSCH for a random access response (RAR) message may be scrambled with an RA-RNTI. DCI for scheduling a PDSCH for a paging message may be scrambled with a P-RNTI. DCI for notifying a slot format indicator (SFI) may be scrambled with an SFI-RNTI. DCI for notifying transmit power control (TPC) may be scrambled with a TPC-RNTI. DCI for scheduling UE-specific PDSCH or PUSCH may be scrambled with C-RNTI (cell RNTI).

For the UE to be scheduled, the base station may apply specific DCI formats depending on whether DCI is scheduling information for downlink data (downlink assignment), scheduling information for uplink data (uplink grant), or for purposes other than data scheduling such as power control.

The base station may transmit downlink data to the UE through the physical downlink shared channel (PDSCH) being a physical channel for downlink data transmission. Scheduling information such as specific mapping position of the PDSCH in the time-frequency domain, modulation scheme, HARQ-related control information, and power control information may be notified by the base station to the UE through DCI related to downlink data scheduling information among DCIs transmitted through the PDCCH.

The UE may transmit uplink data to the base station through the physical uplink shared channel (PUSCH) being a physical channel for uplink data transmission. Scheduling information such as specific mapping position of the PUSCH in the time-frequency domain, modulation scheme, HARQ-related control information, and power control information may be notified by the base station to the UE through DCI related to uplink data scheduling information among DCIs transmitted through the PDCCH.

The time-frequency resource to which the PDCCH is mapped is called a control resource set (CORESET). In the frequency domain, the CORESET may be configured on all or part of the frequency resources of the bandwidth supported by the UE. In the time domain, the CORESET may be configured on one or multiple OFDM symbols, and this may be defined as the CORESET length (control resource set duration). The base station may configure one or multiple CORESETs to the UE through higher layer signaling (e.g., system information, MIB (master information block), or RRC (radio resource control) signaling). Configuring a CORESET to the UE may mean providing information such as CORESET ID (identity), frequency position of the CORESET, and symbol length of the CORESET. The information provided by the base station to the UE to configure a CORESET may include at least some of the information included in Table 4.

```
TABLE 4
ControlResourceSet ::= SEQUENCE {
  controlResourceSetId ControlResourceSetId,
  frequencyDomainResources BIT STRING (SIZE (45)),
    duration INTEGER (1..maxCoReSetDuration),
  cce-REG-MappingType CHOICE {
  interleaved SEQUENCE {
  reg-BundleSize ENUMERATED {n2, n3, n6},
```

interleaverSize ENUMERATED {n2, n3, n6},
shiftIndex INTEGER(0..maxNrofPhysicalResourceBlocks-1)

```
OPTIONAL -- Need S
  },
nonInterleaved NULL
  },
  precoderGranularity ENUMERATED {sameAsREG-bundle, allContiguousRBs},
    tci-StatesPDCCH-ToAddList SEQUENCE(SIZE (1..maxNrofTCI-StatesPDCCH)) OF
TCI-StateId OPTIONAL, -- Cond NotSIB1-initialBWP
  tci-StatesPDCCH-ToReleaseList SEQUENCE(SIZE (1..maxNrofTCI-StatesPDCCH)) OF
TCI-StateId OPTIONAL, -- Cond NotSIB1-initialBWP
  tci-PresentInDCI ENUMERATED {enabled} OPTIONAL, -- Need S
  pdcch-DMRS-ScramblingID INTEGER (0..65535) OPTIONAL, -- Need S
}
```

The CORESET may be composed of N_{RB}^{CORESET} in the frequency domain and may be composed of N_{symb}^{CORESET}∈{1,2,3} symbols in the time domain. The PDCCH may be composed of one or multiple control channel elements (CCEs). One CCE may be composed of 6 resource element groups (REGs), and one REG may be defined as 1 RB during 1 OFDM symbol. In a CORESET, REGs may be indexed in a time-first manner starting at REG index 0 for the first OFDM symbol and the lowest-numbered RB in the CORESET.

As a PDCCH transmission method, an interleaved method and a non-interleaved method may be supported. The base station may configure the UE with whether to use interleaved or non-interleaved transmission for each CORESET through higher layer signaling. Interleaving may be performed on a REG bundle basis. A REG bundle may be defined as a set of one or multiple REGs. The UE may determine the CCE-to-REG mapping scheme in the corresponding CORESET in a manner as shown in Table 5 below based on the interleaved or non-interleaved transmission configured by the base station.

```
TABLE 5
The CCE-to-REG mapping for a control-resource set can be interleaved or non-interleaved
and is described by REG bundles:
  - REG bundle i is defined as REGs {iL, iL + 1,..., iL + L − 1} where L is the REG
  bundle size, i = 0,1, ... , N_{REG}^{CORESET} /L − 1, and N_{REG}^{CORESET} = N_{RB}^{CORESET} N_{symb}^{CORESET} is
  the number of REGs in the CORESET
  - CCE j consists of REG bundles {f(6j/L), f(6j/L + 1), ... , f(6j/L + 6/L − 1)}
  where f(·)is an interleaver
For non-interleaved CCE-to-REG mapping, L = 6 and f(x) = x.
For interleaved CCE-to-REG mapping, L ∈ {2,6}for N_{symb}^{CORESET} = 1 and L ∈ {N_{symb}^{CORESET}, 6}
for N_{symb}^{CORESET} ∈ {2,3}. The interleaver is defined by
                    f(x) = (rC + c + n_{shift)} mod (N_{REG}^{CORESET} /L)
                                x = cR + r
                            r = 0,1, ... , R − 1
                            c = 0,1, ... , C − 1
C = N_{REG}^{CORESET} /(LR)
where R ∈ {2,3,6}.
```

The base station may notify, via signaling, the UE of configuration information such as symbols to which the PDCCH is mapped in a slot, a transmission periodicity, or the like.

The search space for the PDCCH may be described as follows. The number of CCEs required to transmit a PDCCH may be 1, 2, 4, 8, or 16 depending on the aggregation level (AL), and a different number of CCEs may be used for link adaptation of a downlink control channel. For example, when ALL, one downlink control channel may be transmitted by using L CCEs. The UE performs blind decoding for detecting a signal in a state where it does not know information about the downlink control channel, and a search space representing a set of CCEs may be defined for this. The search space is a set of downlink control channel candidates composed of CCEs that the UE may attempt to decode at a given aggregation level, and since there are various aggregation levels that make bundles of 1, 2, 4, 8, and 16 CCEs, respectively, the UE may have multiple search spaces. A search space set may be defined as a set of search spaces at all configured aggregation levels.

The search spaces may be classified into a common search space (CSS) and a UE-specific search space (USS). A specific group of UEs or all UEs may examine the common search space of a PDCCH to receive cell-common control information such as dynamic scheduling of system information or a paging message. For example, the UE may receive scheduling assignment information of the PDSCH for receiving system information by examining the common search space of the PDCCH. Since a specific group of UEs or all UEs need to receive the PDCCH, the common search space may be defined as a set of pre-agreed CCEs. The UE may receive scheduling assignment information for a UE-specific PDSCH or PUSCH by examining the UE-specific search space of a PDCCH. The UE-specific search space may be defined in a UE-specific manner as a function of the UE identity (ID) and various system parameters.

The base station may configure configuration information about the search space of the PDCCH to the UE through higher layer signaling (e.g., SIB, MIB, RRC signaling). For example, the base station may configure the UE with the number of PDCCH candidates at each aggregation level L, a monitoring periodicity for a search space, monitoring occasions in symbols within a slot for the search space, a search space type (common search space or UE-specific search space), a combination of DCI format and RNTI to be monitored in the corresponding search space, and an index of a CORESET in which the search space is to be monitored. For example, parameters for the search space for the PDCCH may include the pieces of information as shown in Table 6 below.

TABLE 6

| | |
|---|---|
| SearchSpace ::= | SEQUENCE { |

```
  searchSpaceId SearchSpaceId,
  controlResourceSetId ControlResourceSetId OPTIONAL, -- Cond SetupOnly
  monitoringSlotPeriodicityAndOffset CHOICE {
  sl1 NULL,
  sl2 INTEGER (0..1),
  sl4 INTEGER (0..3),
  sl5 INTEGER (0..4),
  sl8 INTEGER (0..7),
  sl10 INTEGER (0..9),
  sl16 INTEGER (0..15),
  sl20 INTEGER (0..19),
  sl40 INTEGER (0..39),
  sl80 INTEGER (0..79),
  sl160 INTEGER (0..159),
  sl320 INTEGER (0..319),
  sl640 INTEGER (0..639),
  sl1280 INTEGER (0..1279),
  sl2560 INTEGER (0..2559)
```

| | |
|---|---|
| } | OPTIONAL, -- Cond Setup |
| duration | INTEGER (2..2559) OPTIONAL, -- Need R |

monitoringSymbolsWithinSlot BIT STRING (SIZE (14)) OPTIONAL, -- Cond Setup

| | |
|---|---|
| nrofCandidates | SEQUENCE { |

```
  aggregationLevel1 ENUMERATED {n0, n1, n2, n3, n4, n5, n6, n8},
  aggregationLevel2 ENUMERATED {n0, n1, n2, n3, n4, n5, n6, n8},
  aggregationLevel4 ENUMERATED {n0, n1, n2, n3, n4, n5, n6, n8},
  aggregationLevel8 ENUMERATED {n0, n1, n2, n3, n4, n5, n6, n8},
  aggregationLevel16 ENUMERATED {n0, n1, n2, n3, n4, n5, n6, n8}
```

| | |
|---|---|
| } | OPTIONAL, -- Cond Setup |

searchSpaceType CHOICE {

| | |
|---|---|
| common | SEQUENCE { |

```
  dci-Format0-0-AndFormat1-0 SEQUENCE {
    ...
```

| | |
|---|---|
| } | OPTIONAL, -- Need R |
| dci-Format2-0 | SEQUENCE { |

```
    nrofCandidates-SFI SEQUENCE {
    aggregationLevel1 ENUMERATED {n1, n2} OPTIONAL, -- Need R
    aggregationLevel2 ENUMERATED {n1, n2} OPTIONAL, -- Need R
    aggregationLevel4 ENUMERATED {n1, n2} OPTIONAL, -- Need R
    aggregationLevel8 ENUMERATED {n1, n2} OPTIONAL, -- Need R
    aggregationLevel16 ENUMERATED {n1, n2} OPTIONAL -- Need R
    },
    ...
```

| | |
|---|---|
| } | OPTIONAL, -- Need R |
| dci-Format2-1 | SEQUENCE { |

...

| | |
|---|---|
| } | OPTIONAL, -- Need R |
| dci-Format2-2 | SEQUENCE { |

...

| | |
|---|---|
| } | OPTIONAL, -- Need R |
| dci-Format2-3 | SEQUENCE { |
| dummy1 | ENUMERATED {sl1, sl2, sl4, sl5, sl8, sl10, sl16, sl20} OPTIONAL, -- Cond |

Setup

| | |
|---|---|
| dummy2 | ENUMERATED {n1, n2}, |

...

| | |
|---|---|
| } | OPTIONAL -- Need R |

},

| | |
|---|---|
| ue-Specific | SEQUENCE { |
| dci-Formats | ENUMERATED {formats0-0-And-1-0, formats0-1-And-1-1}, |

```
  ...,
  }
```

| | |
|---|---|
| } | OPTIONAL -- Cond Setup2 |

}

The base station may configure the UE with one or plural search space sets according to the configuration information. According to some embodiments, the base station may configure the UE with search space set 1 and search space set 2. In search space set 1, the UE may be configured to monitor DCI format A scrambled with X-RNTI in the common search space, and in search space set 2, the UE may be configured to monitor DCI format B scrambled with Y-RNTI in the UE-specific search space.

According to the configuration information, one or plural search space sets may be present in the common search space or UE-specific search space. For example, search space set #1 and search space set #2 may be configured as a common search space, and search space set #3 and search space set #4 may be configured as a UE-specific search space.

In the common search space, the UE may monitor, but not limited to, the following combinations of DCI format and RNTI:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

In the UE-specific search space, the UE may monitor, but not limited to, the following combinations of DCI format and RNTI:
DCI format 0_0/0_1 with CRC scrambled by C-RNTI, CS-RNTI, TC-RNTI; and/or
DCI format 1_0/1_1 with CRC scrambled by C-RNTI, CS-RNTI, TC-RNTI.

The above RNTIs may comply with the following definitions and uses:
Cell RNTI (C-RNTI): used for scheduling UE-specific PDSCH or PUSCH;
Temporary cell RNTI (TC-RNTI): used for scheduling UE-specific PDSCH;
Configured scheduling RNTI (CS-RNTI): used for scheduling semi-statically configured UE-specific PDSCH;
Random access RNTI (RA-RANTI): used for scheduling PDSCH at random access stage;
Paging RNTI (P-RNTI): used for scheduling a PDSCH on which paging is transferred;
System information RNTI (SI-RNTI): used for scheduling a PDSCH on which system information is transferred;
Interruption RNTI (INT-RNTI): used for notifying whether to puncture a PDSCH;
Transmit power control for PUSCH RNTI (TPC-PUSCH-RNTI): used for indicating a power control command for PUSCH;
Transmit power Control for PUCCH RNTI (TPC-PUCCH-RNTI): used for indicating a power control command for PUCCH; and/or
Transmit power control for SRS RNTI (TPC-SRS-RNTI): used for indicating a power control command for SRS.

The DCI formats described above may follow the definitions shown in Table 7 below.

TABLE 7

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for |
| | SRS transmissions by one or more UEs |

In CORESET p and search space set s, the search space at aggregation level L may be expressed as Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L \} + i \qquad [ Equation 1 ]$$

where:
L: aggregation level;
nCI: carrier index;
NCCE,p: total number of CCEs in CORESET p;
nus,f: slot index;
M(L)p,s,max: number of PDCCH candidates at aggregation level L;
msnCI=0, . . . , M(L)p,s,max−1: indexes of PDCCH candidates at aggregation level L;
i=0, . . . , L−1; and
Y_{p,n}_{_{s,f}}_{^{μ}}=(Ap·Y_{p,n}_{_{s,f}}_{^{μ}}₋₁)mod D, Y_{p,-1}=n_{RNTI}≠0, A₀=39827, A₁=39829, A₂=39839, D=65537
nRNTI: UE ID.

For the common search space, the value of Y_{p,n}_{_{s,f}}_{^{μ}} may correspond to 0.

For the UE-specific search space, the value of Y_{p,n}_{_{s,f}}_{^{μ}} may correspond to a value that changes depending on the UE ID (ID set to the UE by C-RNTI or base station) and time index.

Next, a detailed description will be given of a method for measuring and reporting channel states in the 5G communication system.

Channel state information (CSI) may include the following information:
CQI (channel quality indicator): information indicating a CQI index composed of a modulation scheme and coding rate that satisfy a preset minimum reception error rate of the PDSCH;
PMI (precoding matrix indicator): information indicating precoding matrices selected by the UE;
CRI (CSI-RS resource indicator): CSI-RS information measured by the UE;
RI (rank indicator): information indicating the rank selected by the UE;
LI (layer indicator): information indicating the best layer among the precoding matrices reported by the UE;
SSBRI (SS/PBCH block resource indicator): information indicating the SSB measured by the UE; and/or
L1-RSRP (reference signal received power): L1 RSRP information measured by the UE.

The base station may control time and frequency resources for the UE to perform CSI measurement and reporting.

As a CSI measurement and reporting operation, “aperiodic,” “semi-persistent,” and “periodic” schemes are supported, and the base station may configure the scheme to be used to the UE through signaling. Semi-persistent CSI reporting supports “PUCCH-based semi-persistent (semi-PersistentOnPUCCH)” and “PUSCH-based semi-persistent (semi-PersistentOnPUSCH).” In the case of periodic or semi-permanent CSI reporting, the UE may be configured with PUCCH or PUSCH resources for CSI transmission by the base station through higher layer signaling. The periodicity and slot offset of the PUCCH or PUSCH resources to be used for CSI transmission may be given by the subcarrier spacing configuration of the uplink (UL) bandwidth part configured to transmit the CSI report. For aperiodic CSI reporting, the UE may be scheduled with PUSCH resources for CSI transmission by the base station through L1 signaling (DCI format 0_1 described above).

Aperiodic CSI reporting of the UE may utilize the PUSCH, periodic CSI reporting may utilize the PUCCH, and semi-persistent CSI reporting may be performed by using the PUSCH if triggered or activated by the DCI or by using the PUCCH after being activated by a MAC control element (MAC CE).

Aperiodic CSI reporting may be triggered by a “CSI request” field of DCI format 0_1 corresponding to scheduling DCI for the PUSCH.

In a wireless communication system, one or more different antenna ports (these may be replaced with one or more channels, signals, or a combination thereof, but will be collectively referred to as “different antenna ports” in the following description of the disclosure for convenience) may be associated with each other according to quasi co-location (QCL) configuration as shown in Table 8 below. The TCI state is intended to notify a QCL relationship between a physical channel A (or the demodulation reference signal (DMRS) of the physical channel A) and another RS or channel B; when a specific reference antenna port A (reference RS #A) and another target antenna port B (target RS #B) are quasi co-located (QCLed), this indicates that the UE is allowed to apply some or all of large-scale channel parameters estimated from the antenna port A to channel measurement from the antenna port B. QCL may be required to associate different parameters depending on the situation, such as 1) time tracking affected by average delay and delay spread, 2) frequency tracking affected by Doppler shift and Doppler spread, 3) radio resource management (RRM) affected by average gain, 4) beam management (BM) affected by spatial parameters, and the like. Accordingly, 5G supports four types of QCL relationships as shown in Table 8 below.

TABLE 8

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

Spatial RX parameters may refer to some or all of various parameters such as angle of arrival (AoA), power angular spectrum (PAS) of AoA, angle of departure (AoD), PAS of AoD, transmit/receive channel correlation, transmit/receive beamforming, spatial channel correlation, and the like.

The QCL relationship may be configured to the UE through RRC parameters TCI-State and QCL-Info as shown in Table 9 below. Referring to Table 9, the base station may configure one or more TCI states for the UE and notify the UE of up to two QCL relationships (qcl-Type1 and qcl-Type2) about the RS referring to the ID of a TCI state, that is, the target RS. Here, each piece of QCL information (QCL-Info) included in each TCI state includes a serving cell index and a BWP index associated with the reference RS indicated by the corresponding QCL information, the type and ID of the reference RS, and the QCL type as shown in Table 8 above.

TABLE 9

| | |
|---|---|
| TCI-State ::= | SEQUENCE { |
| tci-StateId | TCI-StateId, |
| qcl-Type1 | QCL-Info, |

(QCL information of the first reference RS of the target RSs that reference the TCI
state ID)

| | | |
|---|---|---|
| qcl-Type2 | | QCL-Info |
| | OPTIONAL, -- Need R | |

```
    (QCL information of the second reference RS of the target RSs that reference the TCI
state ID)
    ...
  }
```

| | | |
|---|---|---|
| QCL-Info ::= | | SEQUENCE { |
| cell | | ServCellIndex |
| | OPTIONAL, -- Need R | |

(serving cell index of the reference RS indicated by the QCL information)

| | |
|---|---|
| bwp-Id | BWP-Id |

OPTIONAL, -- Cond CSI-RS-Indicated

(reference RS [symbol] BWP index of the reference RS indicated by the QCL information)

| | |
|---|---|
| referenceSignal | CHOICE { |
| csi-rs | NZP-CSI- |

```
RS-ResourceId,
    ssb
    SSB-Index
    (one of CSI-RS ID or SSB ID indicated by the QCL information)
    },
```

| | |
|---|---|
| qcl-Type | ENUMERATED |

```
{typeA, typeB, typeC, typeD},
    ...
  }
```

Next, a description will be given of the bandwidth part (BWP) in the 5G system.

The base station may configure one or multiple bandwidth parts to the UE. BWP configuration information may be transmitted from the base station to the UE through higher layer signaling, for example, radio resource control (RRC) signaling. Among one or more configured bandwidth parts, at least one bandwidth part may be activated. Whether a configured bandwidth part is activated may be transmitted from the base station to the UE semi-statically through RRC signaling or may be changed dynamically through downlink control information (DCI).

According to some embodiments, before being radio resource control (RRC) connected, a UE may be configured by the base station with an initial bandwidth part (initial BWP) for initial connection through a master information block (MIB). To be more specific, in the initial connection stage, the UE may receive, through the MIB, configuration information about a control resource set (CORESET) and search space through which a physical downlink control channel (PDCCH) for receiving system information required for initial connection (remaining system information (RMSI) or system information block 1 (SIB1) can be transmitted. The control resource set and search space configured through the MIB can each be regarded as having an identity (ID) of 0. The base station may notify the UE of configuration information such as frequency assignment information, time assignment information, and subcarrier spacing for control resource set #0 (CORESET #0) through the MIB. Additionally, the base station may notify the UE of configuration information about the monitoring periodicity and occasion for control resource set #0, that is, configuration information about search space #0 (search space #0), through the MIB. The UE may regard the frequency domain set as control resource set #0 obtained from the MIB as the initial bandwidth part for initial connection. At this time, the identity (ID) of the initial bandwidth part may be regarded as 0.

Configuration for the bandwidth part supported by 5G may be used for various purposes.

According to some embodiments, when the bandwidth supported by the UE is smaller than the system bandwidth, this may be supported through the bandwidth part configuration. For example, the base station may configure the frequency location of a bandwidth part to the UE, allowing the UE to transmit and receive data at a specific frequency location within the system bandwidth.

Additionally, according to some embodiments, the base station may configure a plurality of bandwidth parts to the UE for the purpose of supporting different subcarrier spacings. For example, to support data transmission and reception using both a subcarrier spacing of 15 kHz and a subcarrier spacing of 30 kHz for a UE, two bandwidth parts respectively with subcarrier spacings of 15 kHz and 30 kHz may be configured. Different bandwidth parts may be frequency division multiplexed, and for transmitting and receiving data at a specific subcarrier spacing, the bandwidth part configured with the corresponding subcarrier spacing may be activated.

Additionally, according to some embodiments, for the purpose of reducing power consumption of a UE, the base station may configure bandwidth parts with different bandwidth sizes to the UE. For example, if a UE supports a very large bandwidth, for example, a bandwidth of 100 MHz, and always transmits and receives data through that bandwidth, very large power consumption may occur. In particular, monitoring unnecessarily a downlink control channel with a large bandwidth of 100 MHz in a situation where there is no traffic can be very inefficient in terms of power consumption. For the purpose of reducing the power consumption of the UE, the base station may configure a relatively small bandwidth part, for example, a bandwidth part of 20 MHz, to the UE. The UE may perform monitoring operations on the 20 MHz bandwidth part in a situation where there is no traffic, and may, when data is generated, transmit and receive data in the 100 MHz bandwidth part according to the instruction of the base station.

Next, a description will be given of a method for adjusting the waveform of the transmission signal to improve the coverage of a wireless communication system. Coverage is one of the main performance indicators of a wireless communication system that indicates the distance that the transmission signal reaches between the UE and the base station. The greater the coverage, the fewer base stations may be deployed per unit area, which has the advantage of reducing the cost of installing a wireless communication system for the telecommunications operator. In general, the transmission power of the signal transmitted by the base station is greater than the transmission power of the signal transmitted by the UE, so in terms of coverage, the downlink coverage shows more advantageous characteristics than the uplink coverage. Hence, there is a need to relatively improve uplink coverage to balance coverage between downlink and uplink. In the 5G system, two waveforms are defined for the uplink data channel (PUSCH) transmitted by the UE: CP-OFDM (cyclic prefix orthogonal frequency division multiplexing, or OFDM) and DFT-S-OFDM (discrete Fourier transform spread OFDM).

In general, CP-OFDM has the advantage of enabling more flexible resource allocation and relatively low receiver complexity compared to DFT-S-OFDM. In particular, the demodulation performance of high-level MCS (modulation and coding scheme) is superior to DFT-S-OFDM in frequency-selective channels. Hence, CP-OFDM based waveform may be more desirable to achieve high frequency efficiency.

On the other hand, since a low peak to average power ratio (PAPR) may be expected to result in high power amplifier efficiency, low PAPR characteristics are an important factor to be considered for waveforms. Since DFT-S-OFDM has a lower PAPR than CP-OFDM, DFT-S-OFDM has an advantage over CP-OFDM in a power-constrained situation. In other words, when the UE uses a low-level MCS in a power-constrained situation, DFT-S-OFDM may provide relatively high link performance gains, which may immediately lead to coverage improvement. Hence, DFT-S-OFDM may be more suitable in a power-constrained situation.

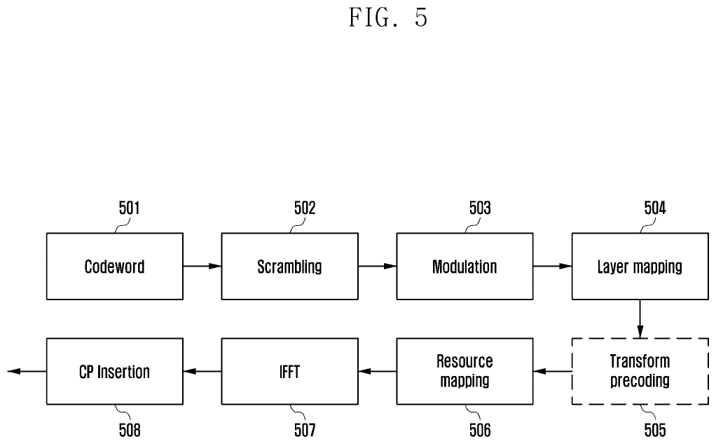

FIG. 5 illustrates a transmission block diagram for a transmission signal generation in a 5G system according to an embodiment of the present disclosure.

With reference to FIG. 5, the transmitter generates a codeword 501 for data to be transmitted and then performs scrambling as a randomization procedure. The scrambled signal (502) is modulated according to a modulation scheme such as QPSK (quadrature phase shift keying) or QAM (quadrature amplitude modulation) (503) and is mapped to a layer (504). Depending on CP-OFDM or DFT-S-OFDM, the layer-mapped signal is mapped directly to resources (506) in the case of CP-OFDM, or is mapped to resources (506) after going through transform precoding (505) in the case of DFT-S-OFDM. The resource-mapped signal is IFFT (inverse fast Fourier transform) processed (507), and CP (cyclic prefix) is inserted (508), and then transmitted through the transmission antenna. In the disclosure, CP-OFDM may be understood as a case where transform precoding is disabled. DFT-S-OFDM may be understood as a case where transform precoding is enabled.

In the 5G system, for transmission and reception between the base station and the UE, CP-OFDM is used in the downlink, and CP-OFDM and DFT-S-OFDM are used in the uplink. The base station may notify the UE of the waveform to be used for the uplink. For example, the base station may indicate the use of CP-OFDM to secure high frequency efficiency, and may indicate the use of DFT-S-OFDM to secure coverage.

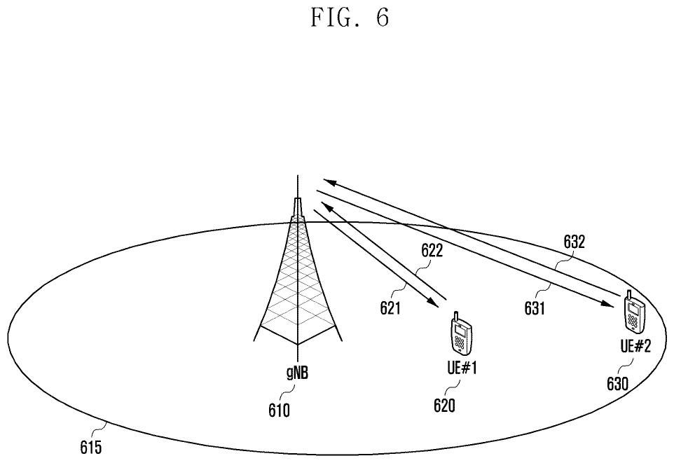

FIG. 6 illustrates an operation of controlling the transmission waveform of a UE according to an embodiment of the present disclosure. Specifically, FIG. 6 illustrates an operation in which the base station instructs a UE to select between CP-OFDM and DFT-S-OFDM as a waveform to be applied to the uplink and the UE transmits the PUSCH accordingly.

FIG. 6 shows a case where UE #1 (620) and UE #2 (630) are present within the coverage 615 of the cell managed by the base station 610. UE #1 is located near the base station (near the cell center) compared to UE #2, so its channel state is relatively good; UE #2 is located relatively far from the base station (near the cell edge) and needs to secure coverage. The base station may determine the situation of each UE on the basis of the channel state information measured and reported by the corresponding UE. In the example of FIG. 6, the base station may determine that the channel state of UE #1 is good and instruct the UE to apply CP-OFDM as the transmission waveform when transmitting the PUSCH (621). Hence, UE #1 transmits the PUSCH with CP-OFDM according to the instruction of the base station (622). On the other hand, the base station may determine that the channel state of UE #2 is poor and that coverage improvement is necessary, and may instruct the UE to apply DFT-S-OFDM as the transmission waveform when transmitting the PUSCH (631). Hence, UE #2 transmits the PUSCH with DFT-S-OFDM according to the instruction of the base station (632).

When the base station instructs the transmission waveform to the UE, it may use at least one of the following methods.
Signaling method 1: instruction via higher layer signaling. As described above, higher layer signaling may be at least one of MIB, SIB, RRC, or MAC CE signaling or a combination thereof. Signaling method 1 has relatively fewer problems due to signaling errors thanks to the higher layer error recovery function, but some transmission delay is inevitable until signaling is completed.
Signaling method 2: instruction via L1 signaling. As described above, L1 signaling may be transmitted via the PDCCH and may include UE-specific DCI or group-common DCI. Signaling method 2 has the feature of enabling fast signaling, while it is relatively likely to cause problems in which the base station and the UE misunderstand due to signaling errors. For example, a “transform precoder indicator” field indicating the PUSCH transmission waveform may be added to DCI format 0_1 indicating uplink data scheduling information (UL grant). If “transform precoder indicator”=0, it means that the transform precoder is activated (i.e., instructs the UE to apply DFT-S-OFDM as the PUSCH transmission waveform); if “transform precoder indicator”=1, it means that the transform precoder is deactivated (i.e., instructs the UE to apply CP-OFDM as the PUSCH transmission waveform).

Since it is too slow to instruct the UE to apply transform precoding through higher layer signaling compared to the speed at which the UE moves from the cell center to the boundary or from the boundary to the cell center, the UE coverage may be not satisfied in certain cases. In such cases, it may be useful to dynamically indicate whether to apply transform precoding via signaling method 2 above.

Next, a description will be given of a PUSCH preparation procedure time. When the base station transmits a PDCCH including DCI for uplink data scheduling of the UE to schedule the UE's PUSCH transmission, the UE may require a PUSCH preparation procedure time for transmitting the PUSCH by applying a transmission scheme indicated through the DCI (transmission precoding scheme of SRS resource, number of transmission layers, spatial domain transmission filter). In 5G, the PUSCH preparation procedure time is defined in consideration of this. The PUSCH preparation procedure time (Tproc, 2) of the UE may follow Equation 2 below.

$${T}_{proc , 2} = max ( ( {N}_{2} + {d}_{2 , 1} + {d}_{2} ) ( 2048 + 144 ) {κ2}^{- μ} {T}_{c} + {T}_{ext} + {T}_{switch} , {d}_{2 , 2} ) . \qquad [ Equation 2 ]$$

In T_{proc,2} described as Equation 2 above, variables may have the following meanings.
N₂: the number of symbols determined according to UE processing capability 1 or 2 and subcarrier spacing configuration u based on the UE capability. When reported as UE processing capability 1 according to the UE capability report of the UE, it has a value of Table 10, and when reported as UE processing capability 2 and configured through higher layer signaling that UE processing capability 2 may be used, it may have a value of Table 11. That is, the UE supporting UE processing capability 2 may perform PUSCH transmission relatively quickly after obtaining scheduling information from the base station compared to the UE supporting UE processing capability 1.

TABLE 10

| | PUSCH preparation time N₂ |
|---|---|
| μ | [symbols] |
| 0 | 10 |
| 1 | 12 |
| 2 | 23 |
| 3 | 36 |

TABLE 11

| | PUSCH preparation time N₂ |
|---|---|
| μ | [symbols] |
| 0 | 5 |
| 1 | 5.5 |
| 2 | 11 for frequency range 1 |

d_{2,1}: the number of symbols being determined to be 0 if the first OFDM symbol of PUSCH transmission is composed of DM-RS (demodulation reference signal) only, and 1 otherwise:
κ: 64;
μ: it follows a value in which Tproc,2 becomes larger among μ_{DL} and μ_{UL}. μ_{DL} denotes the subcarrier spacing configuration of downlink in which a PDCCH including DCI scheduling a PUSCH is transmitted, and μ_{UL} denotes the subcarrier spacing configuration of uplink in which a PUSCH is transmitted;
Tc: it has 1/(Δfₘₐₓ·N_{f}), where Δfₘₐₓ=480·10³ Hz N_{f}=4096;
d2,2: when DCI scheduling the PUSCH indicates BWP switching, it follows a BWP switching time, it is set to 0 otherwise;
d2: when OFDM symbols of a PUSCH with high priority index and a PUCCH with low priority index overlap in time, the d2 value of the PUSCH with high priority index is used. Otherwise d2 is 0;
Text: when the UE uses a shared spectrum channel access scheme, the UE may calculate Text and apply it to the PUSCH preparation procedure time. Otherwise, Text is assumed to be 0; and
Tswitch: when the uplink switching gap is triggered, Tswitch is assumed to be the switching gap time. Otherwise, it is assumed to be 0.

When considering time domain resource mapping information of a PUSCH scheduled through DCI and the timing advance effect between uplink and downlink, the base station and the UE determine that the PUSCH preparation procedure time is not sufficient if the first symbol of the PUSCH starts earlier than the first uplink symbol at which the CP starts after Tproc,2 from the last symbol of the PDCCH including DCI having scheduled the PUSCH. If not, the base station and the UE determine that the PUSCH preparation procedure time is sufficient. Only when the PUSCH preparation procedure time is sufficient, the UE may transmit the PUSCH, and when the PUSCH preparation procedure time is not sufficient, the UE may ignore the DCI having scheduled the PUSCH.

Hereinafter, a description will be given of a PUSCH transmission method of the UE with reference to specific embodiments when the base station dynamically instructs the UE to apply a transmission waveform between DFT-S-OFDM with low PAPR characteristics and CP-OFDM with high frequency efficiency for the PUSCH, which is a bottleneck channel among uplink channels in terms of coverage. The following description is an example of a scheme for indicating a dynamic waveform change for the PUSCH, and may be applied to other channels as well. In the following description of the disclosure, the above examples are described through a number of embodiments, but they are not independent and one or more embodiments may be applied simultaneously or in combination.

### First Embodiment

The first embodiment describes a method for the UE to perform PUSCH transmission operation when the base station instructs the UE to change the PUSCH transmission waveform.

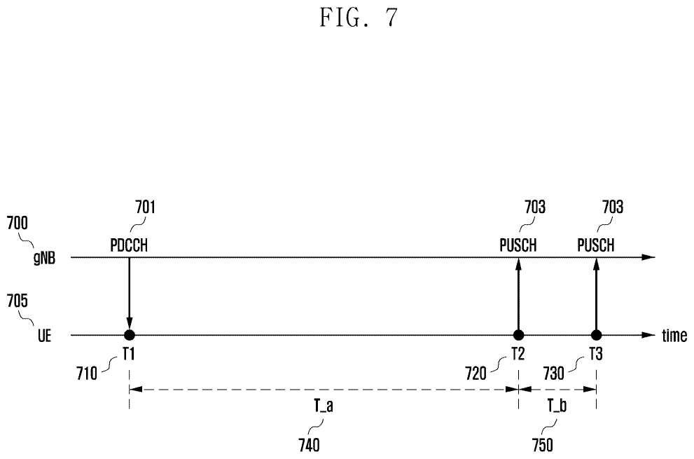

FIG. 7 illustrates a time relationship in which the UE controls the transmission waveform according to an embodiment of the present disclosure.

In the following description, a case where the UE changes the PUSCH transmission waveform according to signaling method 1 and a case where the UE changes it according to signaling method 2 are compared with reference to FIG. 7.

The example of FIG. 7 depicts a situation where the base station 700 transmits a PDCCH 701 including uplink data scheduling information (UL grant) to the UE 705 at time T1 (710) and the UE having received the PDCCH transmits a PUSCH 703 at time T2 (720) or time T3 (730) according to the UL grant.

First, according to signaling method 1, the PUSCH transmission waveform of the UE has already been notified to the UE through higher layer signaling regardless of the UL grant of the PDCCH. For example, the PUSCH transmission waveform of the UE has already been notified before time T1 (710), and the UE performs PUSCH transmission by applying the notified PUSCH transmission waveform to the PUSCH scheduled by the base station in the future. In the example of FIG. 7, the transmission time of the PUSCH for the UL grant of the PDCCH 701 scheduling the PUSCH 703 is T2 (720) regardless of the PUSCH transmission waveform. T_a (740) represents a time interval between the PDCCH scheduling the PUSCH and the PUSCH, and may be included in the control information of the UL grant of the PDCCH. The representation unit of T_a may be a slot, symbol, ms, or the like. Or the representation unit of T_a may be a combination of slot, symbol, ms, or the like. At this time, the relationship T1+T_a≤T2 is satisfied. That is, at least T_a time has elapsed after receiving the PDCCH scheduling the PUSCH (T1), and then the UE transmits the PUSCH through an available uplink radio resource (T2).

Next, according to signaling method 2, the PUSCH transmission waveform of the UE is indicated by the “transform precoder indicator” field included in the UL grant of the PDCCH. Referring to FIG. 5, if the PUSCH transmission waveform is DFT-S-OFDM, the UE requires additional processing according to the transform precoding block 505. Hence, if the PUSCH transmission waveform is determined by the PDCCH scheduling the PUSCH like signaling method 2, it is necessary to consider additional UE processing according to the transmission waveform. In the example of FIG. 7, the time required for additional UE processing according to the transmission waveform is represented by T_b (750). The representation unit of T_b may be a slot, symbol, ms, or the like. Or the representation unit of T_b may be a combination of slot, symbol, ms, or the like. The UE may perform PUSCH transmission by applying additional processing time T_b in at least one of the following cases:
Case 1: the PDCCH scheduling the PUSCH indicates application of DFT-S-OFDM (i.e., activation of the transform precoder) as the PUSCH transmission waveform; and
Case 2: the transmission waveform of the PUSCH indicated by the PDCCH scheduling the PUSCH is different from the transmission waveform of the previously transmitted PUSCH. In other words, the PUSCH transmission waveform is changed by the PDCCH.

If case 1 or case 2 applies, the PUSCH transmission time of the UE becomes T3 (730). At this time, the relationship T1+T_a+T_b≤T3 is satisfied. That is, at least T_a+T_b time has elapsed after receiving the PDCCH scheduling the PUSCH (T1), and then the UE transmits the PUSCH through an available uplink radio resource (T3). On the other hand, if case 1 or case 2 does not apply, the PUSCH transmission time of the UE becomes T2. According to the first embodiment, Equation 2 for calculating the PUSCH preparation procedure time of the UE described above may be replaced with Equation 3 below.

$${T}_{proc , 2} = max ( ( {N}_{2} + {d}_{2 , 1} + {d}_{2} ) ( 2048 + 144 ) {κ2}^{- μ} {T}_{c} + {T}_{ext} + {T}_{switch} + T\_b , {d}_{2 , 2} ) . \qquad [ Equation 3 ]$$

In signaling method 2, T_a (740) represents a time interval between the PDCCH scheduling the PUSCH and the PUSCH, and may be included in the control information of the UL grant of the PDCCH. The representation unit of T_a may be a slot, symbol, ms, or the like. Or the representation unit of T_a may be a combination of slot, symbol, ms, or the like.

T_b (750) may be included in the control information of the UL grant of the PDCCH. In this case, T_a (740) and T_b (750) may be signaled separately. For example, the control information of the UL grant of the PDCCH may include a field indicating T_a (740) and a field indicating T_b (750). As another example, T_a (740) and T_b (750) may be signaled as a single value. For example, the control information of the UL grant of the PDCCH may include a field indicating T_a+T_b.

Alternatively, a UE capability for T_b (750) may be reported from the UE to the base station, and the base station may perform PUSCH scheduling based on the corresponding UE capability.

### Second Embodiment

The second embodiment describes another method for the UE to perform PUSCH transmission operation when the base station instructs the UE to change the PUSCH transmission waveform.

As described above, the base station may determine whether to change the transform precoding for the UE depending on the need for coverage improvement or frequency efficiency improvement due to UE movement. However, frequent changes in transform precoding may have a side effect of increasing UE processing complexity. Therefore, the second embodiment defines a transform precoding change procedure that takes UE complexity into account.

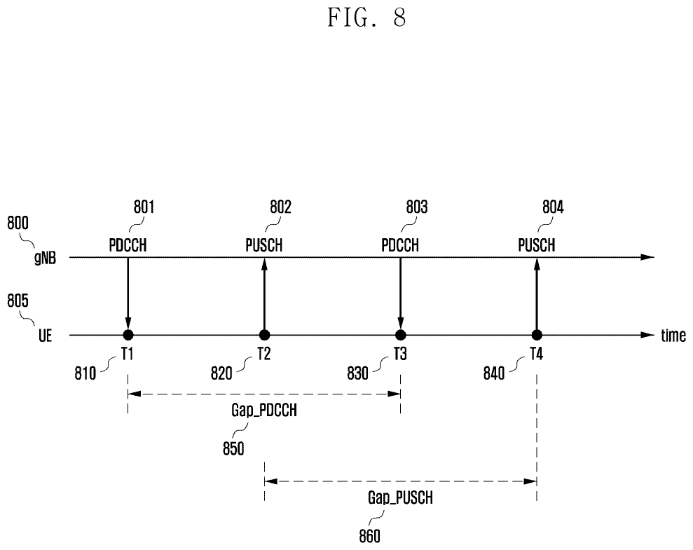

FIG. 8 illustrates another time relationship in which the UE controls the transmission waveform according to an embodiment of the present disclosure.

Referring to FIG. 8, the main operation of the second embodiment is described.

In the example of FIG. 8, the base station 800 transmits a PDCCH 801 including uplink data scheduling information (UL grant) to the UE 805 at time T1 (810), and the UE having received the PDCCH transmits a PUSCH 802 at time T2 (820) according to the corresponding UL grant. Thereafter, the base station 800 transmits a PDCCH 803 including uplink data scheduling information (UL grant) to the UE 805 at time T3 (830), and the UE having received the PDCCH transmits a PUSCH 804 at time T4 (840) according to the corresponding UL grant. Additionally, the time interval between adjacent PUSCH transmission times T2 and T4 is denoted by Gap_PUSCH 860, and the time interval between adjacent PDCCH transmission times T1 and T3 is denoted by Gap_PDCCH 850.

In the second embodiment, the minimum time required to guarantee the processing time for the UE's transform precoding change is defined to be T, and the relationship Gap_PUSCH≥T (hereinafter referred to as condition 1) is to be satisfied. The T value may be included in the UE capability control information reported by the UE to the base station or may be defined as a value agreed upon between the UE and the base station, and the base station may reflect this and schedule PUSCH transmission so as to satisfy condition 1.

In addition, if the transmission waveform is changed between adjacent PUSCHs, condition 1 may be applied, and if the transmission waveform is not changed between adjacent PUSCHs, condition 1 may be not applied. For example, if the base station intends to indicate CP-OFDM as the transmission waveform of the PUSCH 802 at time T2 (820) through the PDCCH 801 and indicate DFT-S-OFDM as the transmission waveform of the PUSCH 804 at time T4 (840) through the PDCCH 803, the base station controls the transmission interval between the PUSCH 802 and the PUSCH 804 so that condition 1 is satisfied. If the UE determines that condition 1 is not satisfied in a situation where the PUSCH transmission waveform is changed, the UE may ignore the UL grant of the PDCCH 803 or skip transmission of the PUSCH 804.

The second embodiment may be modified in various ways. For example, considering that additional processing time is required when the PUSCH transmission waveform is DFT-S-OFDM, condition 1 may be applied only when the transmission waveform between adjacent PUSCHs is changed from CP-OFDM to DFT-S-OFDM.

In another variation, the time interval between adjacent PDCCHs 801 and 803 for instructing the UE to change the transform precoding may be defined to be Gap_PDCCH 850, and the relationship Gap_PDCCH≥T (hereinafter referred to as condition 2) is to be satisfied. Here, T is the minimum time to secure the processing time required for the UE's transform precoding change, and the T value may be included in the UE capability control information reported by the UE to the base station or may be defined as a value agreed upon between the UE and the base station. For example, the base station adjusts the transmission interval between the PDCCH 801 and the PDCCH 803 to as to satisfy condition 2. If the UE determines that condition 2 is not satisfied in a situation where the PUSCH transmission waveform is changed, the UE may ignore the UL grant of the PDCCH 803 or skip transmission of the PUSCH 804.

The expression unit of Gap_PUSCH, Gap_PDCCH, or T may be a slot, symbol, ms, or the like. Or the expression unit of Gap_PUSCH, Gap_PDCCH, or T may be a combination of slot, symbol, ms, or the like.

### Third Embodiment

The third embodiment describes another method for the UE to perform PUSCH transmission operation when the base station instructs the UE to change the PUSCH transmission waveform.

As described above, the PUSCH preparation procedure time of the UE differs depending on UE processing capability 1 or 2. That is, a UE supporting UE processing capability 2 may transmit the PUSCH relatively quickly after obtaining scheduling information from the base station compared to a UE supporting UE processing capability 1. However, since additional UE processing time is required when changing the PUSCH transmission waveform, it may be difficult for the UE supporting UE processing capability 2 to achieve the original intention of rapid PUSCH transmission.

Therefore, the third embodiment aims to support selective PUSCH transmission waveform change according to the UE capability of the UE.

For example, to ensure rapid PUSCH transmission of the UE, a UE supporting UE processing capability 2 does not apply PUSCH transmission waveform change via the PDCCH, and a UE supporting UE processing capability 1 applies PUSCH transmission waveform change via the PDCCH.

As another example, in order not to exceed the maximum allowable time of the existing PUSCH preparation procedure of the UE, a UE supporting UE processing capability 1 does not apply PUSCH transmission waveform change via the PDCCH, and a UE supporting UE processing capability 2 applies PUSCH transmission waveform change via the PDCCH.

As another UE capability to support rapid PUSCH transmission of the UE, there is a UE capability that enables transmission of multiple PUSCHs composed of a small number of symbols within one slot (hereinafter referred to as “multi-PUSCH transmission” UE capability).

For example, the UE supporting “multi-PUSCH transmission” may map PUSCHs composed of 1, 2, 4 or 7 symbols to the same slot and transmit them in a time division multiplexing (TDM) manner. Since one slot is composed of 14 symbols, 1-symbol PUSCH may be transmitted up to 14 times in one slot, 2-symbol PUSCH may be transmitted up to 7 times in one slot, 4-symbol PUSCH may be transmitted up to 3 times in one slot, and 7-symbol PUSCH may be transmitted up to 2 times in one slot.

Likewise, since additional UE processing time is required to change the PUSCH transmission waveform, it may be not desirable for the UE supporting “multi-PUSCH transmission” to change the transmission waveform for each PUSCH transmission within a slot. Hence, the base station does not instruct the UE supporting “multi-PUSCH transmission” to change the PUSCH transmission waveform when scheduling different PUSCHs to be transmitted in the same slot. And, when the base station schedules different PUSCHs to be transmitted in different slots, it may instruct a change in the PUSCH transmission waveform through the PDCCH scheduling the PUSCH.

The UE supporting “multi-PUSCH transmission” does not apply a transmission waveform change to different PUSCHs to be transmitted in the same slot. In addition, the UE supporting “multi-PUSCH transmission” applies the transmission waveform change instruction of the base station to different PUSCHs to be transmitted in different slots.

### Fourth Embodiment

The fourth embodiment describes an example of a UE procedure and a base station procedure when the base station instructs the UE to change the PUSCH transmission waveform according to a preferred embodiment of the disclosure. The UE procedure and base station procedure of the fourth embodiment may be performed in combination with at least one of the first to third embodiments.

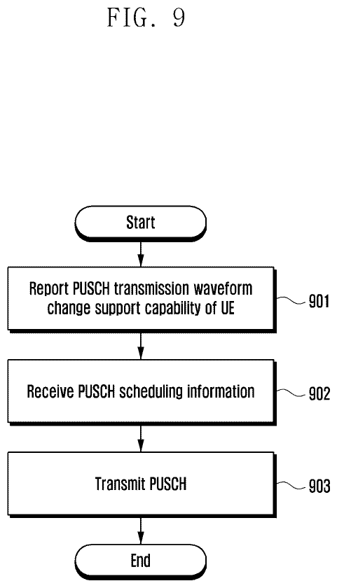

FIG. 9 illustrates a flowchart for describing an example of a UE procedure according to an embodiment of the present disclosure. Specifically, FIG. 9 is a flowchart of a procedure in which the UE performs the corresponding operation according to a base station instruction when the base station indicates a change in the PUSCH transmission waveform.

With reference to FIG. 9, at step 901, when the base station indicates a change in the PUSCH transmission waveform, the UE reports UE capability information including its capability to support this to the base station.

At step 902, the UE may receive scheduling information for scheduling the PUSCH from the base station via the PDCCH. This scheduling information may include “transform precoder indicator” for indicating a change in the PUSCH transmission waveform of the UE, and the detailed method may follow those embodiments described above.

At step 903, the UE transmits the PUSCH to the base station according to the scheduling information. According to the above-described embodiment, additional UE processing time may be applied to the PUSCH transmission waveform change, and the detailed method may follow those embodiments described above.

Steps described with respect to FIG. 9 may be omitted, the order thereof may be changed, or new steps may be added so that the disclosure can be carried out.

For more specific details of the UE operation according to an embodiment of the disclosure illustrated in FIG. 9, reference may be made to the description of the corresponding embodiment of the disclosure described above.

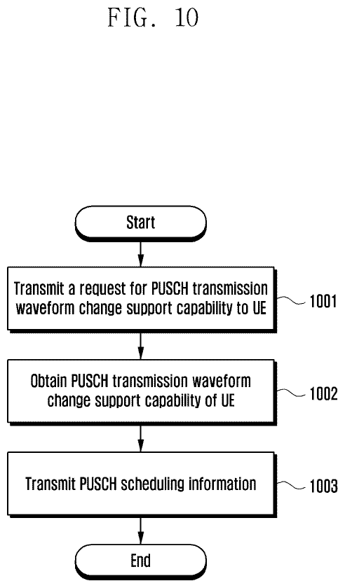

FIG. 10 illustrates a flowchart for describing a base station procedure according to an embodiment of the present disclosure. Specifically, FIG. 10 is a flowchart of a procedure in which the base station instructs the UE to change the PUSCH transmission waveform and performs related operations.

With reference to FIG. 10, at step 1001, the base station may transmit a request for UE capability information to the UE. At step 1002, the base station obtains UE capability information including a PUSCH transmission waveform change support capability from the UE.

Thereafter, at step 1003, the base station transmits scheduling information for scheduling the PUSCH to the UE. According to the above-described embodiment, this scheduling information may include “transform precoder indicator” that instructs a change in the PUSCH transmission waveform of the UE, and the detailed method may follow those embodiments described above. The base station may determine the PUSCH transmission waveform of the UE by referring to the CSI report received from the UE. Then, the base station receives the PUSCH transmitted by the UE based on the above scheduling information.

Steps described with respect to FIG. 10 may be omitted, the order thereof may be changed, or new steps may be added so that the disclosure can be carried out.

For more specific details of the base station operation according to an embodiment of the disclosure illustrated in FIG. 10, reference may be made to the description of the corresponding embodiment of the disclosure described above.

The above flowcharts illustrate exemplary methods that may be implemented in accordance with the principles of the disclosure, and various modifications may be made to the methods illustrated in the flowcharts herein. For example, steps listed in sequence in each drawing may overlap, occur in parallel, occur in different orders, or occur multiple times. In other examples, steps may be omitted or replaced by other steps.

In addition, the methods described in FIGS. 9 and 10 may be performed in combination with at least one of the first to third embodiments.

The fourth embodiment may be modified in many different ways. For example, a procedure is also possible in which the step of the UE reporting the UE capability to the base station is omitted. For example, a procedure is also possible in which the step of the base station transmitting a request for the UE capability to the UE is omitted.

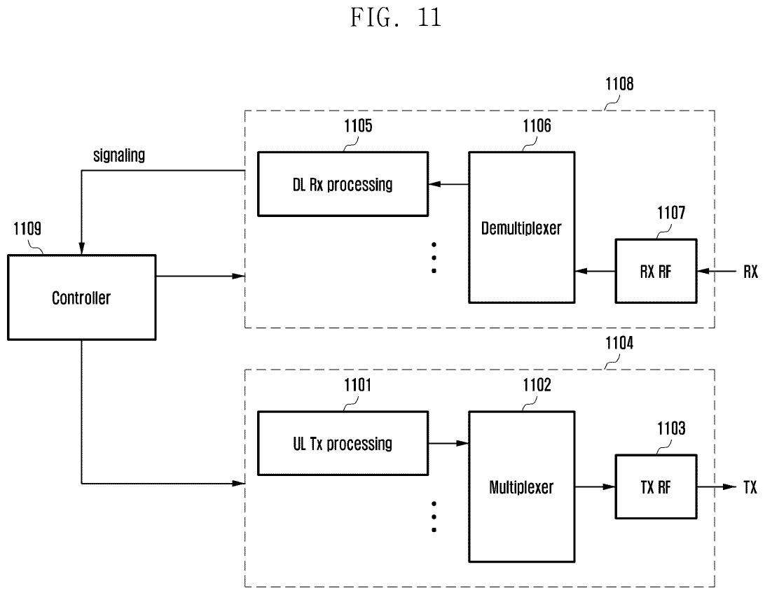

FIG. 11 illustrates a transceiver of a UE in a wireless communication system according to an embodiment of the present disclosure. For convenience of explanation, components not directly related to the disclosure may be omitted from the drawing and description.

With reference to FIG. 11, the UE may be composed of a transmitter 1104 including an uplink transmission processing block 1101, a multiplexer 1102, and a transmission RF block 1103; a receiver 1108 including a downlink reception processing block 1105, a demultiplexer 1106, and a reception RF block 1107; and a controller 1109. The controller 1109 may control individual component blocks of the receiver 1108 for receiving a data channel or control channel transmitted by the base station as described above, and individual component blocks of the transmitter 1104 for transmitting uplink signals.

In the transmitter 1104 of the UE, the uplink transmission processing block 1101 may generate a signal to be transmitted by performing processes such as channel coding and modulation. The signal generated in the uplink transmission processing block 1101 may be multiplexed with other uplink signals by the multiplexer 1102, signal-processed in the transmission RF block 1103, and then transmitted to the base station.

The receiver 1108 of the UE demultiplexes a signal received from the base station and distributes the demultiplexing result to individual downlink reception processing blocks. The downlink reception processing block 1105 may perform processes such as demodulation and channel decoding on the downlink signal of the base station to obtain control information or data transmitted by the base station. The receiver 1108 of the UE may support the operation of the controller 1109 by applying the output result of the downlink reception processing block to the controller 1109.

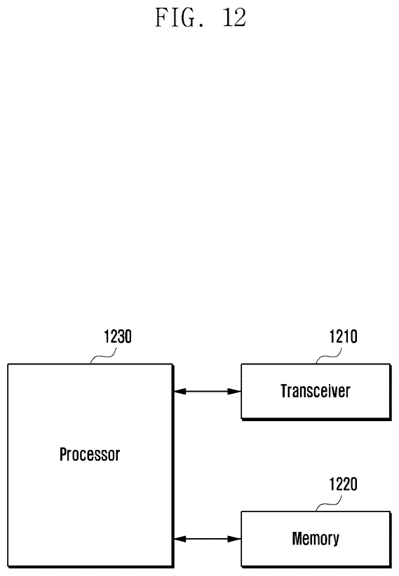

FIG. 12 illustrates a structure of a UE according to an embodiment of the present disclosure.

With reference to in FIG. 12, the UE of the disclosure may include a processor 1230, a transceiver 1210, and a memory 1220. However, the components of the UE are not limited to those described above. For example, the UE may include more or fewer components than the above-described components. Further, the processor 1230, transceiver 1210, and memory 1220 may be implemented in the form of a single chip. According to an embodiment, the transceiver 1210 in FIG. 12 may include the transmitter 1104 and receiver 1108 in FIG. 11. Additionally, the processor 1230 in FIG. 12 may include the controller 1109 in FIG. 11.

According to an embodiment, the processor 1230 may control a series of processes in which the UE can operate according to the above-described embodiments of the disclosure. For example, the processor 1230 may control components of the UE to perform the transmission and reception scheme of the UE in accordance with the instruction to change the PUSCH transmission waveform from the base station according to an embodiment of the disclosure. The processor 1230 may be configured as one or multiple instances, and the processor 1230 may execute programs stored in the memory 1220 to perform UE transmission and reception in a wireless communication system applying operations of the disclosure described above.

The transceiver 1210 may transmit and receive signals to and from a base station. The signals transmitted and received to and from a base station may include control information, and data. The transceiver 1210 may be composed of an RF transmitter that up-converts the frequency of a signal to be transmitted and amplifies the signal, and an RF receiver that low-noise amplifies a received signal and down-converts the frequency thereof. However, this is only an embodiment of the transceiver 1210, and the components of the transceiver 1210 are not limited to the RF transmitter and RF receiver. Additionally, the transceiver 1210 may receive a signal through a radio channel and output it to the processor 1230, and may transmit a signal output from the processor 1230 through a radio channel.

According to an embodiment, the memory 1220 may store programs and data necessary for the operation of the UE. Additionally, the memory 1220 may store control information or data included in signals transmitted and received by the UE. The memory 1220 may be composed of a storage medium such as ROM, RAM, hard disk, CD-ROM, and DVD, or a combination of storage media. Further, the memory 1220 may be configured as multiple instances. According to an embodiment, the memory 1220 may store programs for performing transmission and reception operations of the UE in response to a request for a channel state measurement report from the base station, which are embodiments of the disclosure described above.

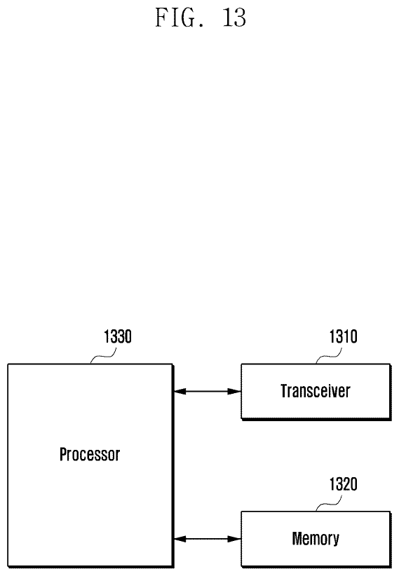

FIG. 13 illustrates a structure of a base station according to an embodiment of the present disclosure.

As shown in FIG. 13, the base station of the disclosure may include a processor 1330, a transceiver 1310, and a memory 1320. However, the components of the base station are not limited to those described above. For example, the base station may include more or fewer components than the above-described components. In addition, the processor 1330, transceiver 1310, and memory 1320 may be implemented in the form of a single chip.

The processor 1330 may control a series of processes so that the base station can operate according to the above-described embodiments of the disclosure. For example, the processor 1330 may control components of the base station to perform the method of determining the PUSCH transmission waveform and scheduling the UE correspondingly according to an embodiment of the disclosure. The processor 1330 may be configured as one or multiple instances, and the processor 1330 may perform the method of the disclosure described above for scheduling a UE according to a channel state measurement reporting request to the UE by executing programs stored in the memory 1320.

The transceiver 1310 may transmit and receive signals to and from a UE. The signals transmitted and received to and from a UE may include control information, and data. The transceiver 1310 may be composed of an RF transmitter that up-converts the frequency of a signal to be transmitted and amplifies the signal, and an RF receiver that low-noise amplifies a received signal and down-converts the frequency thereof. However, this is only an embodiment of the transceiver 1310, and the components of the transceiver 1310 are not limited to the RF transmitter and RF receiver. Additionally, the transceiver 1310 may receive a signal through a radio channel and output it to the processor 1330, and may transmit a signal output from the processor 1330 through a radio channel.

According to an embodiment, the memory 1320 may store programs and data necessary for the operation of the base station. Additionally, the memory 1320 may store control information or data included in signals transmitted and received by the base station. The memory 1320 may be composed of a storage medium such as ROM, RAM, hard disk, CD-ROM, and DVD, or a combination of storage media. Further, the memory 1320 may be configured as multiple instances. According to an embodiment, the memory 1320 may store programs for performing the method of determining the PUSCH transmission waveform and scheduling the UE accordingly, which are embodiments of the disclosure described above.

The methods according to the embodiments described in the claims or specification of the disclosure may be implemented in the form of hardware, software, or a combination thereof.

When implemented in software, a computer-readable storage medium storing one or more programs (software modules) may be provided. The one or more programs stored in the computer-readable storage medium are configured to be executable by one or more processors of an electronic device. The one or more programs include instructions that cause the electronic device to execute the methods according to the embodiments described in the claims or specification of the disclosure.

Such a program (software module, software) may be stored in a random access memory, a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, or a magnetic cassette. Or such a program may be stored in a memory composed of a combination of some or all of them. In addition, a plurality of component memories may be included.

In addition, such a program may be stored in an attachable storage device that can be accessed through a communication network such as the Internet, an intranet, a local area network (LAN), a wide LAN (WLAN), or a storage area network (SAN), or through a communication network composed of a combination thereof. Such a storage device may access the device that carries out an embodiment of the disclosure through an external port. In addition, a separate storage device on a communication network may access the device that carries out an embodiment of the disclosure.

In the specific embodiments of the disclosure, the elements included in the disclosure are expressed in a singular or plural form according to the provided specific embodiment. However, the singular or plural expression is appropriately selected for ease of description according to the presented situation, and the disclosure is not limited to a single element or plural elements. Those elements described in a plural form may be configured as a single element, and those elements described in a singular form may be configured as plural elements.

Meanwhile, the embodiments of the disclosure disclosed in the present specification and drawings are provided as specific examples to easily explain the technical contents of the disclosure and help understanding of the disclosure, and are not intended to limit the scope of the disclosure. Although specific terms have been used, they are used only in a general sense of easily describing the technical content of the disclosure and aiding in the understanding of the disclosure, and are not intended to limit the scope of the disclosure. Additionally, it is apparent to those of ordinary skill in the art to which the disclosure pertains that other modifications can be carried out based on the technical spirit of the disclosure. Further, the above embodiments may be operated in combination with each other as needed. For example, the base station and the terminal may be operated by combining parts of one embodiment and another embodiment of the disclosure with each other. Furthermore, the embodiments of the disclosure are applicable to other communication systems, and other modifications based on the technical ideas of the embodiments may also be carried out.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving, via a physical downlink control channel (PDCCH), downlink control information (DCI) scheduling a physical uplink shared channel (PUSCH) transmission, wherein the DCI includes first information associated with a PUSCH transmission waveform;
determining, based on the first information, whether the PUSCH transmission waveform is a discrete Fourier transform spread orthogonal frequency division multiplexing (DFT-s-OFDM) or the PUSCH transmission waveform is changed from a recent PUSCH transmission waveform;
identifying, based on a processing time parameter, a PUSCH preparation time for the PUSCH transmission waveform that is the DFT-s-OFDM or the PUSCH transmission waveform that is changed from the recent PUSCH transmission waveform;
determining whether to transmit the PUSCH transmission based on the PUSCH preparation time; and
transmitting the PUSCH transmission based on determining to transmit the PUSCH transmission.

2. The method of claim 1, wherein the DCI includes second information on the processing time parameter.

3. The method of claim 1, wherein a UE capability for the processing time parameter is transmitted and the PUSCH transmission is scheduled based on the UE capability for the processing time parameter.

4. The method of claim 1, further comprising, in case that the PUSCH transmission waveform is changed from the recent PUSCH transmission waveform:
determining whether a PUSCH gap between the PUSCH transmission and a recent PUSCH transmission corresponding to the recent PUSCH transmission waveform is equal to or higher than a first threshold; and
determining whether a PDCCH gap between the PDCCH and a recent PDCCH scheduling the PUSCH transmission is equal to or higher than a second threshold,
wherein whether to transmit the PUSCH transmission is further determined based on whether the PUSCH gap is equal to or higher than the first threshold and whether the PDCCH gap is equal to or higher than the second threshold, and
wherein the PUSCH transmission is transmitted in case that the PUSCH gap is equal to or higher than the first threshold and the PDCCH gap is equal to or higher than the second threshold.

5. The method of claim 1, further comprising transmitting a UE capability indicating whether the UE is available to process the first information,
wherein the DCI includes the first information in case that the UE is available to process the first information.

6. A user equipment (UE) in a communication system, the UE comprising:
a transceiver; and
a processor coupled with the transceiver and configured to:
receive, via a physical downlink control channel (PDCCH), downlink control information (DCI) scheduling a physical uplink shared channel (PUSCH) transmission, wherein the DCI includes first information associated with a PUSCH transmission waveform;
determine, based on the first information, whether the PUSCH transmission waveform is a discrete Fourier transform spread orthogonal frequency division multiplexing (DFT-s-OFDM) or the PUSCH transmission waveform is changed from a recent PUSCH transmission waveform;
identify, based on a processing time parameter, a PUSCH preparation time for the PUSCH transmission waveform that is the DFT-s-OFDM or the PUSCH transmission waveform that is changed from the recent PUSCH transmission waveform;
determine whether to transmit the PUSCH transmission based on the PUSCH preparation time; and
transmit the PUSCH transmission based on determining to transmit the PUSCH transmission.

7. The UE of claim 6, wherein the DCI includes second information on the processing time parameter.

8. The UE of claim 6, wherein a UE capability for the processing time parameter is transmitted and the PUSCH transmission is scheduled based on the UE capability for the processing time parameter.

9. The UE of claim 6, wherein the processor is further configured to, in case that the PUSCH transmission waveform is changed from the recent PUSCH transmission waveform:
determine whether a PUSCH gap between the PUSCH transmission and a recent PUSCH transmission corresponding to the recent PUSCH transmission waveform is equal to or higher than a first threshold; and
determine whether a PDCCH gap between the PDCCH and a recent PDCCH scheduling the PUSCH transmission is equal to or higher than a second threshold,
wherein whether to transmit the PUSCH transmission is further determined based on whether the PUSCH gap is equal to or higher than the first threshold,
whether the PDCCH gap is equal to or higher than the second threshold, and
wherein the PUSCH transmission is transmitted in case that the PUSCH gap is equal to or higher than the first threshold and the PDCCH gap is equal to or higher than the second threshold.

10. The UE of claim 6, wherein the processor is further configured to transmit a UE capability indicating whether the UE is available to process the first information, and
wherein the DCI includes the first information in case that the UE is available to process the first information.

11. A method performed by a base station in a communication system, the method comprising:
determine whether a physical uplink shared channel (PUSCH) transmission waveform is a discrete Fourier transform spread orthogonal frequency division multiplexing (DFT-s-OFDM) or the PUSCH transmission waveform is changed from a recent PUSCH transmission waveform;
identifying, based on a processing time parameter, a PUSCH preparation for the PUSCH transmission waveform that is the DFT-s-OFDM or the PUSCH transmission waveform that is changed from the recent PUSCH transmission waveform;
transmitting, via a physical downlink control channel (PDCCH), downlink control information (DCI) scheduling the PUSCH transmission, wherein the DCI includes first information associated with the PUSCH transmission waveform; and
receiving the PUSCH transmission associated with the PUSCH preparation time.

12. The method of claim 11, wherein the DCI includes second information on the processing time parameter.

13. The method of claim 11, wherein a user equipment (UE) capability for the processing time parameter is received and the PUSCH transmission is scheduled based on the UE capability for the processing time parameter.

14. The method of claim 11, wherein, in case that the PUSCH transmission waveform is changed from the recent PUSCH transmission waveform, the PUSCH transmission is received in case that a PUSCH gap is equal to or higher than a first threshold and a PDCCH gap is equal to higher than a second threshold,
wherein the PUSCH gap is a gap between the PUSCH transmission and a recent PUSCH transmission corresponding to the recent PUSCH transmission waveform, and
wherein the PDCCH gap is a gap between the PDCCH and a recent PDCCH scheduling the PUSCH transmission.

15. The method of claim 11, further comprising receiving a UE capability indicating whether a UE is available to process the first information,
wherein the DCI includes the first information in case that the UE is available to process the first information.

16. A base station in a communication system, the base station comprising:
a transceiver; and
a processor coupled with the transceiver and configured to:
determine whether a physical uplink shared channel (PUSCH) transmission waveform is a discrete Fourier transform spread orthogonal frequency division multiplexing (DFT-s-OFDM) or the PUSCH transmission waveform is changed from a recent PUSCH transmission waveform,
identify, based on a processing time parameter, a PUSCH preparation for the PUSCH transmission waveform that is the DFT-s-OFDM or the PUSCH transmission waveform that is changed from the recent PUSCH transmission waveform,
transmit, via a physical downlink control channel (PDCCH), downlink control information (DCI) scheduling the PUSCH transmission, wherein the DCI includes first information associated with the PUSCH transmission waveform, and
receive the PUSCH transmission associated with the PUSCH preparation time.

17. The base station of claim 16, wherein the DCI includes second information on the processing time parameter.

18. The base station of claim 16, wherein a user equipment (UE) capability for the processing time parameter is received and the PUSCH transmission is scheduled based on the UE capability for the processing time parameter.

19. The base station of claim 16, wherein, in case that the PUSCH transmission waveform is changed from the recent PUSCH transmission waveform, the PUSCH transmission is received in case that a PUSCH gap is equal to or higher than a first threshold and a PDCCH gap is equal to higher than a second threshold,
wherein the PUSCH gap is a gap between the PUSCH transmission and a recent PUSCH transmission corresponding to the recent PUSCH transmission waveform, and
wherein the PDCCH gap is a gap between the PDCCH and a recent PDCCH scheduling the PUSCH transmission.

20. The base station of claim 16, wherein the processor is further configured to receive a UE capability indicating whether a UE is available to process the first information, and wherein the DCI includes the first information in case that the UE is available to process the first information.
